(19) United States
(12) Patent Application Publication
(10) Pub. No.: US 2026/0140672 A1
(43) Pub. Date: May 21, 2026

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: TORU KOHATA, Tokyo (JP)

(21) Appl. No.: 19/389,331

(22) Filed: Nov. 14, 2025

(30) Foreign Application Priority Data
Nov. 18, 2024 (JP) 2024-200916
Oct. 10, 2025 (JP) 2025-171943

(51) Int. Cl. G06F 3/12

(52) U.S. Cl. CPC G06F 3/1205; G06F 3/1258

(57) ABSTRACT

An information processing apparatus of the present disclosure includes: a display control unit configured to perform control to display a plurality of setting candidates for a first setting item and execute identification display in which the setting candidate that has been set in the past among the plurality of setting candidates is indicated; a reception unit configured to receive an operation of selecting one of the plurality of setting candidates; a setting unit configured to set the selected setting candidate among the plurality of setting candidates; and a control unit configured to perform control to cancel the identification even in a case where the plurality of setting candidates are displayed, display based on execution of a specific operation from a user after execution of the identification display.

### BACKGROUND

### Field of the Technology

The present disclosure relates to a display processing technique of multiple selectable setting candidates.

### Description of the Related Art

Japanese Patent Laid-Open No. 2017-117026 discloses a method of obtaining information including types of sheets set in sheet feeding units of a printer from the printer and reflecting the information in print setting.

### SUMMARY

An information processing apparatus according to one aspect includes at least one memory and at least one processor which function as: a display control unit configured to perform control to display a plurality of setting candidates for a first setting item and execute identification display in which the setting candidate that has been set in the past among the plurality of setting candidates is indicated; a reception unit configured to receive an operation of selecting one of the plurality of setting candidates; a setting unit configured to set the selected setting candidate among the plurality of setting candidates; and a control unit configured to perform control to cancel the identification display even in a case where the plurality of setting candidates are displayed, based on execution of a specific operation from a user after execution of the identification display.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an example of a configuration of a printing system;

FIG. 2 is a diagram illustrating an example of functional blocks of a printer driver;

FIGS. 3A and 3B are diagrams illustrating an example of a print setting dialog box;

FIG. 4 is a diagram illustrating an example of a print objective table;

FIGS. 5A to 5C are diagram illustrating examples of setting history information according to a first embodiment;

FIGS. 6A and 6B are a flowchart illustrating an example of a print setting process according to the first embodiment;

FIG. 7 is a diagram illustrating an example of a tooltip;

FIG. 8 is a diagram illustrating an example of a message dialog box;

FIG. 9 is a diagram illustrating an example of another message dialog box;

FIGS. 10A to 10C are diagrams illustrating examples of setting history information according to a second embodiment;

FIG. 11 is a flowchart illustrating an example of a print setting process according to the second embodiment;

FIGS. 12A to 12C are diagrams illustrating examples of a list according to the second embodiment;

FIGS. 13A and 13B are diagrams illustrating examples of the setting history information after update according to the second embodiment;

FIGS. 14A to 14C are diagrams illustrating examples of setting history information according to a third embodiment;

FIG. 15 is a flowchart illustrating an example of a print setting process according to the third embodiment;

FIGS. 16A to 16C are diagram illustrating examples of a list according to the third embodiment;

FIGS. 17A and 17B are diagrams illustrating examples of the setting history information after update according to the third embodiment;

FIG. 18 is a diagram illustrating a detailed flowchart of a process for displaying a menu;

FIG. 19 is a diagram illustrating an example of the menu;

FIG. 20A is a diagram illustrating a display example of a history information management dialog;

FIG. 20B is a diagram illustrating a display example of a deletion confirmation dialog;

FIG. 21A is a diagram illustrating a first display example of error display;

FIG. 21B is a diagram illustrating a second display example of the error display; and

FIG. 21C is a diagram illustrating a third display example of the error display.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

### Outline

A print medium is used to form an image (that is perform printing) in a printer. In this specification, the print medium not only means paper but also widely means objects capable of receiving ink such as cloth, plastic, a vinyl sheet, a compact disc (CD), a metal plate, glass, ceramics, wood, and leather. In the following description, explanation is given assuming that the print medium is a paper sheet, but the print medium is not limited to the paper sheet.

There are wide variety of sheet types and the like. There is a case where printing is performed by transmitting print data from an information processing apparatus (for example, personal computer) connected to a printer to the printer. In this case, the user selects the sheet type and the like through a setting screen (GUI) of a printer driver installed in the information processing apparatus.

However, in the GUI of the printer driver, there are various setting items other than a setting item of sheet type, and the setting items vary depending on application of a print product desired by the user. For example, there is a case where a certain user desires to print a poster on a plain paper, but another user desires to a print a CAD drawing on the plain paper. Specifically, there is a case where the application of the print product for the same type of sheet varies depending on the user. Accordingly, the user needs to select setting candidates of the setting items depending on the application of the desired print product. An example of improving usability relating to setting is thus explained below.

### Configuration of System

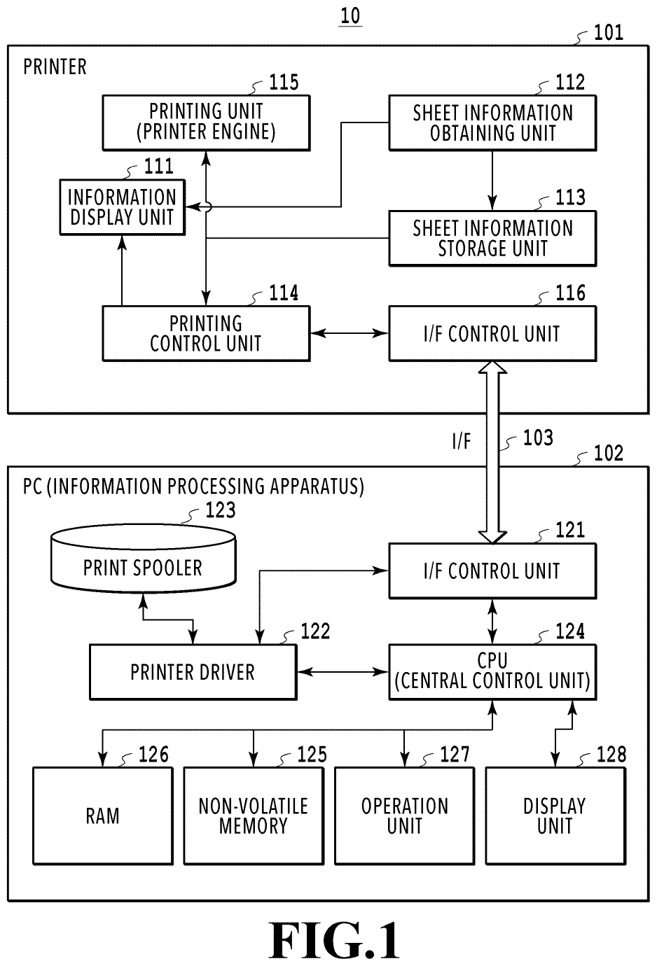

FIG. 1 is a block diagram of a printing system according to the present embodiment. The printing system 10 according to the present embodiment has a configuration in which a printer 101 and a personal computer (hereinafter referred to as PC) 102 are connected to each other by a communication interface 103. However, the printing system 10 according to the present embodiment is not limited to this configuration. For example, the printing system 10 may be an apparatus-integrated system in which functions of the printer 101 and functions of the PC 102 are integrated.

The printer 101 is an apparatus that performs image formation. The printer 101 may be also referred to as an image forming apparatus, a printing apparatus, or the like. The printer 101 performs the image formation based on print data generated in the PC 102. The printer 101 includes multiple sheet feeding units. A roll paper can be attached (also referred to as set) to each of the multiple sheet feeding units. Although the printer 101 is an inkjet-type color printer in the present embodiment, the printer 101 is not limited to this. For example, the printer 101 may be a thermal printer, a dot-impact printer, an LED printer, a laser printer, or the like.

The PC 102 is an information processing apparatus. The PC 102 performs print setting, generation of the print data, and control of the printer 101, based on user operations. An operating system (OS) is embedded in the PC 102, and various functional modules operate on the OS.

The communication interface 103 connects the printer 101 and the PC 102 to each other, and allows exchange of information between the PC 102 and the printer 101. The communication interface 103 is a network such as the Internet or a LAN, but may be a bus (signal line) such as a serial bus or a parallel bus. For example, in the case of the apparatus-integrated printing system described above, the communication interface 103 may be a bus. Moreover, the communication interface 103 may be a wired interface, a wireless interface, or a combination of a wired interface and a wireless interface. The communication interface 103 may be any interface as long as it implements bi-directional communication.

In the following description, explanation of contents that relate to the printer 101 and the PC 102 and that are assumed not to be particularly necessary for explanation of features of the present embodiments is omitted as necessary.

The printer 101 includes an information display unit 111, a sheet information obtaining unit 112, a sheet information storage unit 113, a printing control unit 114, a printing unit 115, and an I/F control unit 116.

The information display unit 111 is means for performing display based on information. For example, the information display unit 111 performs display of sheet information obtained in the sheet information obtaining unit 112, print information (for example, warning information) controlled in the printing control unit 114, and the like. The information display unit 111 includes a display device such as a LED display device.

The sheet information obtaining unit 112 is means for obtaining the sheet information. The sheet information is information on the sheet set in each sheet feeding unit. The sheet information includes information indicating the sheet type and information indicating the sheet size. The sheet feeding units are included as part of the printing unit 115. The sheet information obtaining unit 112 includes input means such as a button that allows the user to set the sheet information. The sheet information obtaining unit 112 obtains the sheet information based on a user operation performed on the input means. In the case where a sensor is attached to each sheet feeding unit, the sheet information obtaining unit 112 may obtain the sheet information by reading the sheet information with the sensor.

The sheet information storage unit 113 is means for storing the sheet information. For example, the sheet information storage unit 113 is implemented by a non-volatile storage device such as a hard disk or a flash memory. The sheet information obtained by the sheet information obtaining unit 112 is stored in the sheet information storage unit 113.

The printing control unit 114 is means for controlling printing. The printing control unit 114 receives the print data transmitted from the PC 102, and send the received print data in the printing unit 115. The print data transmitted from the PC 102 is data subjected to image processing by the PC 102 based on the print setting. The print data may include a command for printing control. In the case where the print data includes the command for printing control, the printing control unit 114 controls a printer engine according to the command for printing control.

As a specific example, the print data may be formed of binary data for printing (intermediate data before binarization in some cases) and various commands for controlling an applying amount of the ink, the number of passes, a print direction, and a conveyance amount of the print medium.

There may be used print data obtained by combining RGB three-channel bitmap type image data (hereinafter, referred to as RGB image data) and data in which commands for print setting are described. In this case, the printing control unit 114 performs processes such as an image process on the RGB image data and a process of conversion to binary data that can be handled in the printing unit 115. Moreover, the printing control unit 114 obtains information including the applying amount of the ink, the number of passes, the print direction, and the conveyance amount of the print medium, based on the sheet type and the sheet size included in the commands of the print setting. The printing control unit 114 send the obtained information and the binary data in the printing unit 115 as the print data.

The printing unit 115 is means for executing printing (image formation). The printing unit 115 is also referred to as printer engine. The printing unit 115 performs printing on the sheet being a print target (print product) based on the print data sent from the printing control unit 114. For example, the printing unit 115 performs printing by ejecting the ink.

The I/F control unit 116 is responsible for an interface function of the printer 101. The I/F control unit 116 executes predetermined communication control, and performs communication with the PC 102 via the communication interface 103.

The PC 102 includes an I/F control unit 121, a printer driver 122, a print spooler 123, a CPU (central control unit) 124, a non-volatile memory 125, a RAM 126, an operation unit 127, and a display unit 128.

The I/F control unit 121 is responsible for an interface function of the PC 102. The I/F control unit 121 executes predetermined communication control, and performs communication with the printer 101 via the communication interface 103.

The printer driver 122 is an application program (software) for performing processes such as the print setting, the generation of the print data, and the control of the printer 101 on the PC 102. The printer driver 122 is recorded in the non-volatile memory 125.

The print spooler 123 sequentially stores pieces of print data generated by the printer driver 122. The print data stored in the print spooler 123 is transferred to the printer 101. The storage and the transfer of the print data are performed asynchronously. Accordingly, even in the case where a generation process of the print data by the printer driver 122 is executed quicker than a printing process by the printer 101, the printer driver 122 can continuously execute the generation process of the print data without waiting for the printing process by the printer 101. Accordingly, efficient processes are achieved.

The CPU 124 is a central control unit that controls various functions of the PC 102. The CPU 124 includes at least one processor. The CPU 124 performs execution of programs or various processes by activating hardware. The execution of programs is performed by loading the programs into the RAM 126. The processes performed by the CPU 124 include display control in which control is performed such that display targets are displayed in the display unit 128. The CPU 124 may perform the display control in cooperation with a not-illustrated GPU.

The non-volatile memory 125 stores various pieces of data. For example, the non-volatile memory 125 stores the programs to be executed by the CPU 124 or data necessary for operations of the PC 102. The RAM 126 is used as a work area of the CPU 124. The RAM 126 may be used as a temporary storage region of the data.

The operation unit 127 includes an operation device (input device) such as a keyboard, a touch panel, and a mouse. The operation unit 127 receives various inputs for reflecting intentions of the user in the print setting, based on operations performed on the operation unit 127. A click that is one type of operation can be performed on the operation unit 127. For example, in the case where the operation unit 127 includes a mouse, the click is an operation of pressing and releasing a mouse button. In the case where the operation unit 127 includes a touch panel, the click is an operation of touching the touch panel with the finger and releasing the finger from the touch panel.

The display unit 128 includes a display. The display unit 128 displays warning, contents of the print setting, and the like on the display to notify the user of the warning, the contents of the print setting, and the like. Note that the display unit 128 may perform notification using an audio output from a speaker or the like, in addition to the notification by display.

### Configuration of Printer Driver

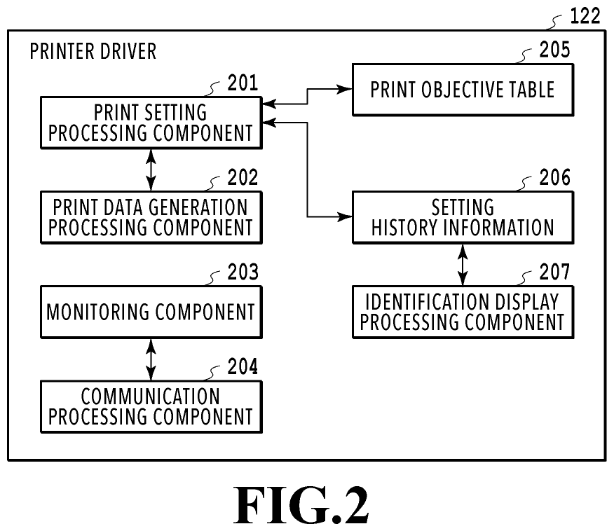

FIG. 2 is a diagram illustrating an example of a configuration of the printer driver 122. The printer driver 122 includes a print setting processing component 201, a print data generation processing component 202, a monitoring component 203, a communication processing component 204, a print objective table 205, setting history information 206, and an identification display processing component 207.

Each of the print setting processing component 201, the print data generation processing component 202, the monitoring component 203, the communication processing component 204, and the identification display processing component 207 is a functional block. The CPU 124 implements these functional blocks by loading a program including the printer driver 122 into the RAM 126. These functional blocks may be at least partially implemented by an integrated circuit such as an ASIC or a FPGA or by an electronic circuit including a discrete device.

The print setting processing component 201 is a processing component that performs the print setting. The print setting includes setting of a type of a sheet to be used, setting of a size of the sheet to be used, and setting of print quality. The print setting processing component 201 performs the print setting based on the information inputted from the operation unit 127, the print objective table 205, the setting history information 206, and the like. The print setting processing component 201 has a function of displaying contents, selected or designated based on instructions or inputs from the user, on the display unit 128 via a GUI to notify the user of the contents.

The print data generation processing component 202 generates the print data based on the print setting performed in the print setting processing component 201, and spools the generated print data in the print spooler 123. Note that, in the case where the print data generation processing component 202 determines that printing is not possible due to reasons such as mismatching of the print setting in the print data generation, the print data generation processing component 202 displays information warning this mismatch on the display unit 128.

The monitoring component 203 is a processing component that controls the transfer of the print data spooled in the print spooler 123. The communication processing component 204 sequentially transfers the pieces of print data to the printer 101 via the I/F control unit 121. The monitoring component 203 controls the transfer of the print data by controlling the communication processing component 204.

The monitoring component 203 obtains print setting information indicating the contents of the print setting, by analyzing the contents of the print data before the transfer of the print data to the printer. Moreover, the monitoring component 203 obtains status information from the printer 101 by performing bidirectional communication with the printer 101. The monitoring component 203 controls the transfer of the print data to the printer 101, based on the obtained print setting information and the status information. The status information includes the sheet information, information indicating a progress status of a printing process, and information indicating an ink remaining amount.

The communication processing component 204 performs a communication process with the printer 101 via the I/F control unit 121 according to an instruction of the monitoring component 203. The communication process between the communication processing component 204 and the printer 101 has a bidirectional characteristic. This bidirectional communication process includes a process of transferring data such as the print data to the printer 101 and a process of obtaining the status information from the printer 101. In the case where an error occurs in the printer 101 during the transfer of data or the like, the communication processing component 204 obtains information on the error from the printer 101. In this case, the monitoring component 203 displays the error information obtained by the communication processing component 204, on the display unit 128.

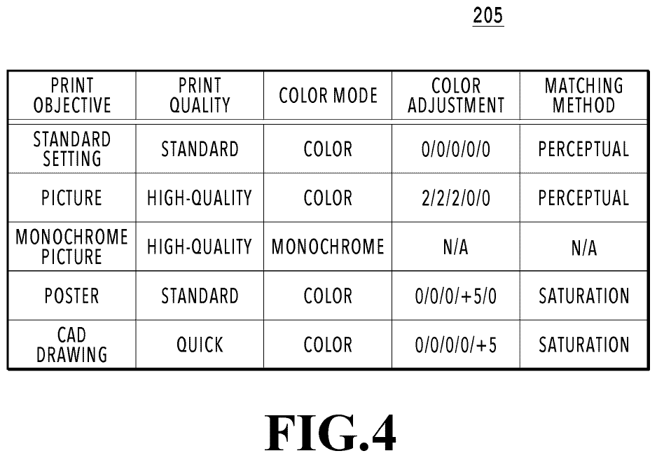

The print objective table 205 is a table for enabling setting of a set of parameters corresponding to setting items relating to the print quality as a whole. The print objective table 205 is recorded in the non-volatile memory 125, but is not limited to this. For example, the print objective table 205 may be recorded in a server on the Internet or the like. Details of the print objective table 205 are described later by using FIG. 4.

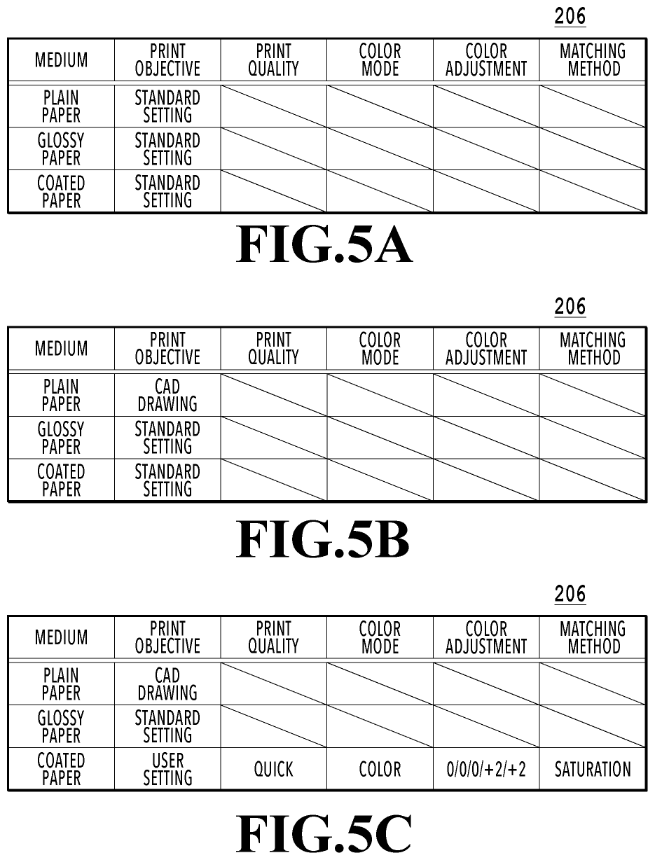

The setting history information 206 is information indicating contents of the print setting performed in the print setting processing component 201, as history. The setting history information 206 is recorded in the non-volatile memory 125, but is not limited to this. For example, the setting history information 206 may be recorded in a server on the Internet. Details of the setting history information 206 are described later by using FIGS. 5A to 5C.

The identification display processing component 207 is a processing component that displays setting candidates that have set in the past in an identifiable manner based on the setting history information 206. This identification display is performed in the case where multiple setting candidates that fall under the setting item of sheet type are displayed on the display unit 128. The identification display processing component 207 may refer to the setting history information 206, and check the sheet type for which information indicating that this sheet type has been set in the past is held. In the case where the identification display processing component 207 displays multiple sheet types as the setting candidates based on this check, the identification display processing component 207 performs processes such that the sheet types for which the information indicating that this sheet type has been set in the past is held and the sheet types for which this information is not held are identifiable from one another.

### Display Contents of Print Setting Dialog

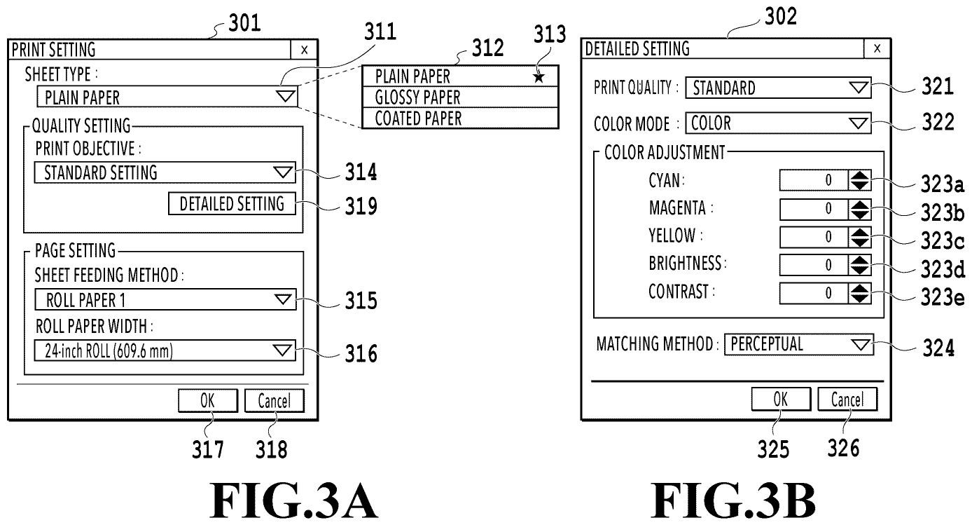

FIG. 3A is a diagram illustrating an example of a print setting dialog box 301. FIG. 3B is a diagram illustrating a print quality detailed setting dialog box 302.

The print setting dialog box 301 is a GUI of the printer driver 122 compatible with the printer 101. The print setting dialog box 301 is displayed in the display unit 128 as a print setting screen. The CPU 124 (print setting processing component 201) that has received a display command of the print setting screen displays the print setting dialog box 301. The display command of the print setting screen is outputted from the operation unit 127 based on an operation performed on the operation unit 127 by the user who desires to perform the print setting. In the print setting dialog box 301, print setting relating to print data generation such as sheet, sheet feeding method, and print quality can be performed.

Multiple setting items relating to the print setting are displayed in the print setting dialog box 301. Setting items of “sheet type”, “print objective”, “sheet feeding method”, and “roll paper width” are displayed in the example of FIG. 3A.

A pull-down list 311 is provided for the setting item of “sheet type”. The pull-down list 311 is a control that allows the user to selectively set the sheet type set in the sheet feeding unit of the printer 101. Note that, in the present specification, the control means an element that can receive a user operation on a GUI screen or that can display information on the GUI screen. Moreover, a control that receives the user operation is also referred to as operation item, operation icon, or the like. Moreover, the pull-down list is also referred to as pull-down menu.

A name of the currently-selected setting candidate (currently-selected target) and a mark for displaying a list of multiple setting candidates are displayed in the pull-down list 311. In the example of FIG. 3A, the currently-selected target is “plain paper”. The mark is displayed as a black inverted triangle whose vertex is pointing downward as in a display form of “▾”, but is not limited to this. In the case where the user clicks the mark of the pull-down list 311, a menu 312 including multiple setting candidates prepared as the sheet type is displayed. In the example of FIG. 3A, the multiple setting candidates prepared as the sheet type are “plain paper”, “glossy paper”, and “coated paper”. The user can select a desired setting candidate from these setting candidates.

The multiple setting candidates displayed in the menu 312 are arranged side by side in a specific direction determined in advance. The specific direction is, for example, a downward direction in the pull-down list 311, but is not limited to this. The order in which the multiple setting candidates are arranged side by side is fixed. Specifically, rearrangement of the setting candidates is not performed. Accordingly, the user is more likely to intuitively grasp a position where each sheet type is arranged in the menu 312.

In the example of FIG. 3A, an icon 313 is displayed for the setting candidate of “plain paper”. Meanwhile, the icon 313 is not displayed for the setting candidates of “glossy paper” and “coated paper”. The icon 313 is a black star shape as in a display form of “★”, but is not limited to this. The icon 313 indicates that the information indicating that the setting candidate has been set in the past is held. The icon 313 is displayed by the identification display processing component 207. Although not illustrated, in the case where the information indicating that the setting candidate has been set in the past is held for none of the multiple setting candidates included in the menu 312, no icon 313 is displayed. Specifically, the icon 313 displayed by the identification display processing component 207 achieves a state where the setting candidate (plain paper) for which the information indicating that the setting candidate has been set in the past is held is distinguished from the setting candidate (glossy paper and coated paper) for which the information indicating that the setting candidate has been set in the past is not held.

“The setting candidate has been set in the past” means that the setting has been finalized in the setting screen. For example, assume a state where no icon 313 is displayed in the menu 312 (that is a state where the information indicating that the setting candidate has been set in the past is not held). Moreover, assume that the sheet type selected by using the pull-down list 311 in this assumed state is glossy paper. In this case, if the menu 312 is displayed again by using the pull-down list 311 without pressing of an OK button 317, no icon 313 is displayed for glossy paper. This is because the setting is not finalized in the setting screen unless the OK button 317 is pressed.

A pull-down list 314 is provided for the setting item of “print objective”. The print objective is provided to allow the set of parameters relating to the print quality to be set simultaneously. The pull-down list 314 is a control that allows the user to selectively set the print objective. In the example of FIG. 3A, a currently-selected target is “standard setting”. The “standard setting” is an initial value in the case where the print setting dialog box 301 is displayed for the first time. In the case where the user clicks a mark in the pull-down list 314, a list including multiple setting candidates prepared as the print objective is displayed. Although this list is not illustrated, the multiple setting candidates prepared as the print objective include, for example, “standard setting”, “picture”, “monochrome picture”, “poster”, “CAD drawing”, and “user setting”. The user can select a desired setting candidate from among these setting candidates.

Note that, although the setting candidate of the print objective selected by the user is displayed as the currently-selected target in the pull-down list 314, the present disclosure is not limited to this. For example, in the case where the user selects the setting candidate of the sheet type in the pull-down list 311, a setting value of the print objective corresponding to the selected setting candidate of the sheet type may be automatically displayed as the currently-selected target. For example, the print setting processing component 201 may perform this display by referring to the setting history information 206 and the like. This can reduce the number of setting candidates to be selected by the user, and burden of the user is reduced.

Moreover, the pull-down list 314 may be provided with a period in which an operation of the user is disabled (operation disabled period). This operation disabled period lasts until, for example, the PC 102 obtains the sheet information from the printer 101 and contents based on the sheet information are reflected. The user operation on the pull-down list 311 may be enabled or disabled during the operation disabled period of the pull-down list 314. The same applies to a pull-down list 315 and a pull-down list 316 to be described later.

The pull-down list 315 is provided for the setting item of “sheet feeding method”. The pull-down list 315 is a control that allows the user to selectively set the sheet feeding unit from which the sheet is to be fed from among the multiple sheet feeding units included in the printer 101. In the example of FIG. 3A, a currently-selected target is “roll paper 1”. In the case where the user clicks a mark in the pull-down list 315, a list including multiple setting candidates prepared as the sheet feeding method is displayed. Although this list is not illustrated, the multiple setting candidates prepared as the sheet feeding method are, for example, “roll paper 1” and “roll paper 2”. “Roll paper 1” corresponds to a first sheet feeding unit of the printer 101, and “roll paper 2” corresponds to a second sheet feeding unit of the printer 101. The user can select a desired setting candidate out of these setting candidates.

The pull-down list 316 is provided for the setting item of “roll paper width”. The pull-down list 316 is a control that allows the user to selectively set the width of the roll paper set in the sheet feeding unit set in the pull-down list 315. In the example of FIG. 3A, a currently-selected target is “24-inch roll (609.6 mm)”. In the case where the user clicks a mark in the pull-down list 316, a list including setting candidates of numbers prepared as the roll paper width is displayed. Although this list is not illustrated, the setting candidates of the numbers prepared as the roll paper width are, for example, “24-inch roll (609.6 mm)” and “A1/A2 roll (594.0 mm)”. The user can select a desired setting candidate out of these setting candidates.

The print setting dialog box 301 is provided with the OK button 317 and a cancel button 318. The OK button 317 is pressed in the case where the print setting of the currently-selected targets is to be finalized. In the case where the OK button 317 is pressed, the print setting processing component 201 performs the print setting of the currently-selected targets on the printer driver 122. The cancel button 318 is pressed in the case where the print setting of the currently-selected targets is to be discarded. In the case where the cancel button 318 is pressed, the print setting processing component 201 does not perform the print setting of the currently-selected targets on the printer driver.

The print setting dialog box 301 is provided with a detailed setting button 319. The detailed setting button 319 is provided in a region of quality setting together with the pull-down list 314. The detailed setting button 319 is a button enabled in the case where “user setting” is selected as a quality target. In the case where the detailed setting button 319 is pressed, the CPU 124 (print setting processing component 201) displays a detailed setting dialog box 302. The detailed setting dialog box 302 is a GUI of the printer driver 122 compatible with the printer 101. The user uses the detailed setting dialog box 302 to select (designate) parameters (setting values) of the print quality by himself/herself.

In the detailed setting dialog box 302, multiple setting items relating to the detailed setting are displayed. In the example of FIG. 3B, setting items of “print quality”, “color mode”, “cyan”, “magenta”, “yellow”, “brightness”, “contrast”, and “matching method” are displayed.

A pull-down list 321 is provided for the setting item of “print quality”. The pull-down list 321 is a control that allows the user to selectively set the print quality. In the example of FIG. 3B, a currently-selected target is “standard”. In the case where the user clicks a mark in the pull-down list 321, a list including multiple setting candidates prepared as the print quality is displayed. Although this list is not illustrated, the multiple setting candidates prepared as the print quality are, for example, “standard”, “quick”, and “high quality”. The user can select a desired setting candidate from among these setting candidates.

A pull-down list 322 is provided for the setting item of “color mode”. The pull-down list 322 is a control for setting whether or not a print original is to be printed by being converted to a monochrome color. In the example of FIG. 3B, a currently-selected target is “color”. In the case where the user clicks a mark in the pull-down list 322, a list including multiple setting candidates prepared as “color mode” is displayed. Although this list is not illustrated, the multiple setting candidates prepared as “color mode” are “color” and “monochrome”. The user can select a desired setting candidate out of these setting candidates.

The setting items of “cyan”, “magenta”, “yellow”, “brightness”, and “contrast” are provided in a region of color adjustment. Corresponding adjustment controls 323a to 323e are provided for the respective setting items. In each of the adjustment controls 323a to 323e, an adjustment value can be changed in increments of one in a range of −30 or more to +30 or less. An initial value of the adjustment value of each of the adjustment controls 323a to 323e is “0”. The user can select a desired adjustment value as the setting candidate.

A pull-down list 324 is provided for the setting item of “matching method”. In the example of FIG. 3B, in the pull-down list 324, a currently-selected target is “perceptual”. In the case where the user clicks a mark in the pull-down list 324, a list including multiple setting candidates prepared as “matching method” is displayed. Although this list is not illustrated, the multiple setting candidates prepared as “matching method” are “perceptual” and “saturation”. The user can select a desired setting candidate out of these setting candidates.

The detailed setting dialog box 302 is provided with an OK button 325 and a cancel button 326. The OK button 325 is pressed in the case where the detailed print setting is to be finalized. The cancel button 326 is pressed in the case where the detailed print setting is to be discarded. In the case where the OK button 325 or the cancel button 326 is pressed, the detailed setting dialog box 302 is closed, and display goes into a state where the print setting dialog box 301 is active.

### Contents of Print Objective Table

FIG. 4 is a diagram illustrating an example of the print objective table 205. The print objective table 205 holds multiple print objectives and information indicating print quality corresponding to each of the print objectives in association with one another. Each of the print objectives held in the print objective table 205 is defined in advance as a recommended item (standard item). Each of the print objectives held in the print objective table 205 is displayed as the setting candidate of the pull-down list 314 (FIG. 3A).

The information indicating print quality includes parameters (setting value), respectively, of “print quality”, “color mode”, “color adjustment”, and “matching method”. These parameters are defined in advance as a default set (standard set) for each print objective.

In the example of FIG. 4, in the case where the print objective is “standard setting”, “print quality” is “standard”, “color mode” is “color”, “color adjustment” is “0/0/0/0/0”, and “matching method” is “perceptual”. Here, “0/0/0/0/0” means that the adjustment value of each of “cyan”, “magenta”, “yellow”, “brightness”, and “contrast” is “0”. Refer to FIG. 4 for the case where the print objective is “picture”, “monochrome picture”, “poster”, or “CAD drawing”.

The print objective table 205 may be used to perform the print setting without causing the user to input multiple setting items relating to print quality. For example, assume that the OK button 317 is pressed in a state where the user has selected the setting candidate of “standard setting” from the pull-down list 314 (see FIG. 3A) corresponding to the setting item of print objective. In this case, a setting value indicating “standard” is automatically set (set in the print setting) as “print quality” in the printer driver 122. Moreover, a setting value indicating “color” is set as “color mode”, a setting value indicating “0/0/0/0/0” is set as “color adjustment”, and a setting value indicating “perceptual” is set as “matching method” in the printer driver 122.

### Contents of Setting History Information

FIGS. 5A to 5C are diagram illustrating examples of the setting history information 206. Specifically, FIG. 5A is a diagram illustrating an example of an initial state of the setting history information 206. Moreover, FIG. 5B is a diagram illustrating an example of a state where the setting history information 206 is updated. Furthermore, FIG. 5C is a diagram illustrating an example of another state where the setting history information 206 is updated.

The setting history information 206 is information indicating correspondence between the sheet type and information (quality history information) indicating print quality setting contents as history. In other words, the setting history information 206 means a table in which setting values that indicate the print quality and that are set as specific contents of the print setting by the print setting processing component 201 are held for each sheet type.

Multiple sheet types for which the print setting can be performed are stored in the item of “medium” in the setting history information 206. The sheet types are the same as the sheet types displayed as the setting candidates in the menu 312 of the pull-down list 311 (see FIG. 3A).

A setting value indicating one of the multiple print objectives displayed as the setting candidates in the list of the pull-down list 314 (see FIG. 3A) is stored in the item of “print objective” in the setting history information 206. Specifically, a setting value indicating one of “standard setting”, “picture”, “monochrome picture”, “poster”, “CAD drawing”, and “user setting” is stored.

A setting value indicating contents designated (selected) by the user is stored in “print quality” of the setting history information 206. The same applies to “color mode”, “color adjustment”, and “matching method”.

In the case where the setting history information 206 is in the initial state, each of the multiple sheet types is associated with a print objective defined as default. In the example of FIG. 5A, each of “plain paper”, “glossy paper”, and “coated paper” is associated with “standard setting”. Note that each of the sheet types is associated with nothing for “print quality”, “color mode”, “color adjustment”, and “matching method”.

Assume that the print setting is changed thereafter in the print setting dialog box 301 (see FIG. 3A). For example, assume that the OK button 317 is pressed in a state where “plain paper” is selected as the sheet type and the print objective of “plain paper” is changed from “standard setting” to “CAD drawing”. In this case, the setting history information 206 is updated by the identification display processing component 207. Specifically, the setting history information 206 changes from the state illustrated in FIG. 5A to the state illustrated in FIG. 5B. In other words, “standard setting” associated with “plain paper” in the setting history information 206 is changed to a setting value indicating “CAD drawing”.

Moreover, assume that the printing process is executed in a state where the print objective of “plain paper” is “CAD drawing”, and then the print setting is changed in the print setting dialog box 301 in another printing occasion. For example, assume that the OK button 317 is pressed in a state where “coated paper” is selected as the sheet type and the print objective of “coating paper” is changed from “standard setting” to “user setting”. In this case, the setting history information 206 is updated by the identification display processing component 207 again. Specifically, the setting history information 206 changes from the state illustrated in FIG. 5B to the state illustrated in FIG. 5C. To be more specific, “standard setting” associated with “coated paper” in the setting history information 206 is changed to a setting value indicating “user setting”. Moreover, setting values indicating contents designated by the user in the detailed setting dialog box 302 (FIG. 3B) are stored in “print quality”, “color mode”, “color adjustment”, and “matching method” associated with “coated paper” in the setting history information 206. The example of FIG. 5C illustrates the case where “quick” is designated in the pull-down list 321, “color” is designated in the pull-down list 322, “+2” is designated in the adjustment control 323d, “+2” is designated in the adjustment control 323e, and “saturation” is designated in the pull-down list 324.

### Print Setting Process

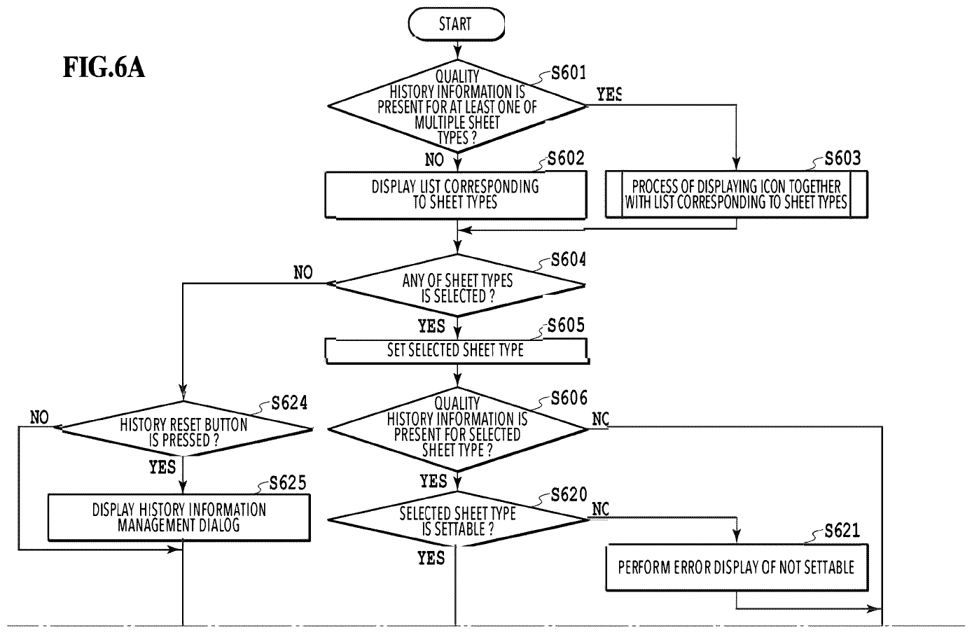

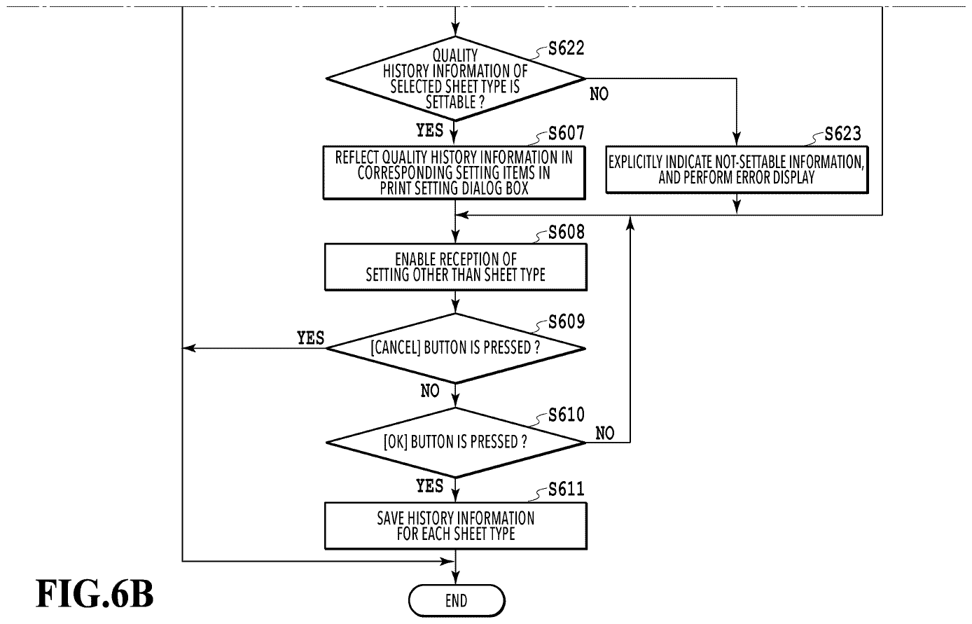

FIGS. 6A and 6B are a flowchart illustrating an example of a series of processes (print setting process) according to the first embodiment. The CPU 124 implements the series of processes illustrated in FIG. 6 A and 6B by loading a program included in a package of an application program (printer driver 122) into the RAM 126. Note that part or all of functions of the steps in FIG. 6 A and 6B may be implemented by hardware such as an ASIC or an electronic circuit. The symbol “S” in explanation of each process means step in the corresponding flowchart (the same applies to the flowcharts in this specification from here on).

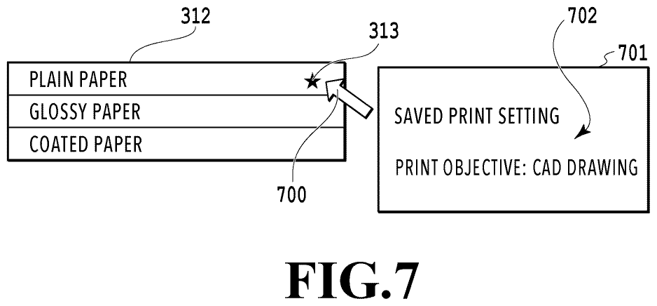

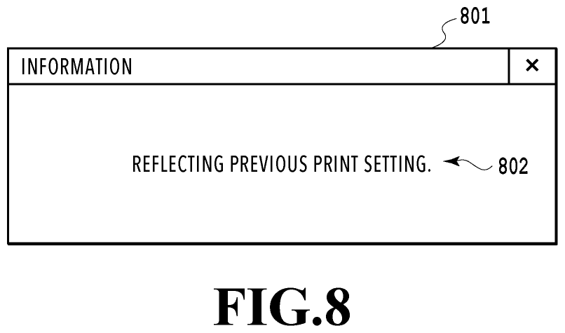

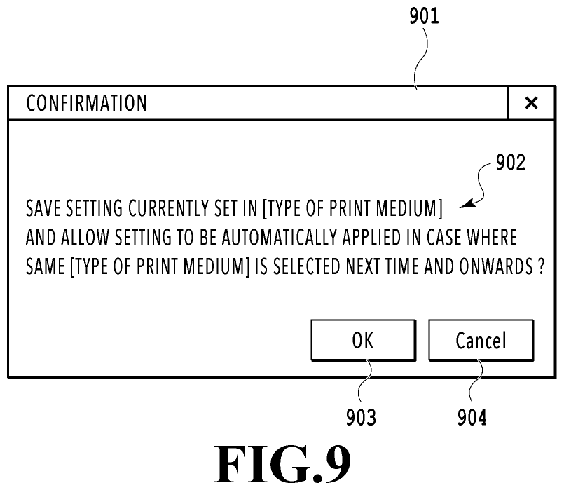

FIG. 7 is a diagram illustrating an example of a tooltip 701. FIG. 8 is a diagram illustrating an example of a message dialog box 801. FIG. 9 is a diagram illustrating an example of another message dialog box 901. Explanation is given below by using FIGS. 6 to 9.

The print setting process illustrated in FIG. 6 A and 6B are started in the case where the CPU 124 receives a display command of the menu 312 for the setting item of sheet type in a state where the print setting dialog box 301 (FIG. 3A) is displayed in the display unit 128. The display command is supplied from the operation unit 127 to the CPU 124 by being triggered by an operation of clicking the mark of the pull-down list 311 or the like.

In S601, the CPU 124 determines whether a sheet type set in the past is present or not, based on the setting history information 206 stored in the non-volatile memory 125. Specifically, the CPU 124 refers to the setting history information 206, and determines whether the quality history information is present for at least one sheet type or not.

Here, in the case where the setting history information 206 is in the initial state illustrated in FIG. 5A, the standard setting is set for all of the multiple sheet types included in the menu 312. In this case, the user has never made print setting different from the standard setting in the past. Accordingly, in the case where the setting history information 206 is in the initial state, the CPU 124 determines that the quality history information is absent for all sheet types.

Meanwhile, in the case where the setting history information 206 is in the state illustrated in FIG. 5B, the standard setting is not set for “plain paper” included in the menu 312. In this case, the user has made print setting (CAD drawing setting) different from the standard setting in the past. Moreover, in the case where the setting history information 206 is in the state illustrated in FIG. 5C, the standard setting is not set for “plain paper” and “coated paper” included in the menu 312. In this case, the user has made print setting (CAD drawing setting and user setting) different from the standard setting in the past. Accordingly, in the case where the setting history information 206 is in the state illustrated in FIG. 5B or the state illustrated in FIG. 5C, the CPU 124 determines that the quality history information is present for at least one sheet type.

If the determination result of S601 is false (NO), the process proceeds to S602. In S602, the CPU 124 displays the menu 312 corresponding to the sheet type. In the case where the menu 312 is displayed, the process proceeds to S604.

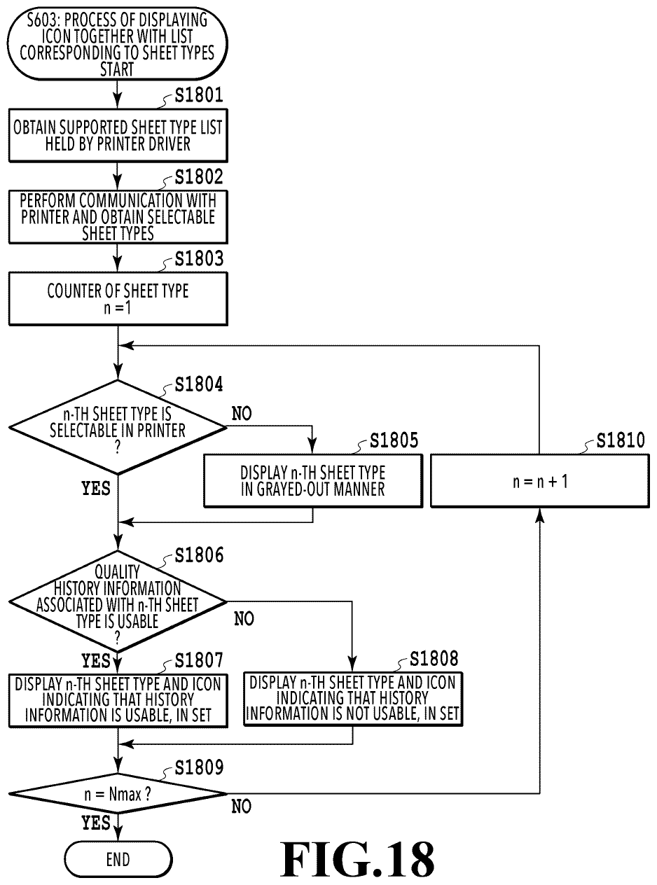

If the determination result of S601 is true (YES), the process proceeds to S603. In S603, the CPU 124 displays the menu 312 corresponding to the sheet types, and also displays the icon 313 in association with a specific sheet type. The specific sheet type is the sheet type for which the quality history information is determined to be present in S601. Details of the process of S603 are described later by using FIG. 18.

For example, as illustrated in FIG. 3A, the icon 313 is displayed in the frame of “plain paper” in the menu 312 in the case where the setting history information 206 is in the state illustrated in FIG. 5B. Meanwhile, although not illustrated, the icon 313 is displayed in the frame of each of “plain paper” and “coated paper” in the menu 312 in the case where the setting history information 206 is in the state illustrated in FIG. 5C. In the case where the icon 313 is displayed together with the menu 312, the process proceeds to S604.

FIG. 18 illustrates a detailed flowchart of the process of S603 that is the process for displaying the menu 312.

In S1801, the CPU 124 obtains a supported sheet type list held by the printer driver 122.

In S1802, the CPU 124 performs communication with the printer 101, and obtains information on sheet types that are supported by the printer 101 and that are selectable in the printer 101. The supported sheet type list held by the printer 101 is a static list preset in installing. Since actually-usable sheet type setting is the sheet types selectable in the printer 101, the information is dynamically obtained in S1802.

In S1803, the CPU 124 starts a display process of the menu 312 from the head of the supported sheet type list obtained in S1802. Specifically, the CPU 124 initializes a counter n to 1, the counter n indicating an ordinal number of the sheet type from the head of the supported sheet type list obtained in S1801.

In S1804, the CPU 124 determines whether the n-th sheet type from the head of the supported sheet type list obtained in S1801 is selectable in the printer 101 or not, based on the information obtained from the printer 101 in S1802. If the determination result of S1804 is true (YES), the process proceeds to S1806. Meanwhile, if the determination result of S1804 is false (NO), the process proceeds to S1805, and then proceeds to S1806.

In S1805, the CPU 124 displays the n-th sheet type from the head of the supported sheet type list obtained in S1801, on the menu 312 in a grayed-out manner. Specifically, the CPU 124 displays the n-th sheet type such that the fact that the n-th sheet type is not selectable can be identified.

In S1806, the CPU 124 determines whether the quality history information associated with the n-th sheet type from the head of the supported sheet type list obtained in S1801 is usable or not. As a specific example, assume the case where the setting history information 206 is in the state illustrated in FIG. 5C. In this case, a case where the setting of “color mode: color” used at the time of storing of the quality history information in the past cannot be currently used due to reasons such as an insufficient chromatic color ink remaining amount is conceivable. In this case, the CPU 124 determines that the setting of “color mode: color” is not usable in S1806. Since cases like the case described above occur, the determination of S1806 is performed to clarify the currently-usable quality history information. If the determination result of S1806 is true (YES), the process proceeds to S1807, and then proceeds to S1809. Meanwhile, if the determination result of S1806 is false (NO), the process proceeds to S1808, and then proceeds to S1809.

In S1807, the CPU 124 displays the n-th sheet type from the head of the supported sheet type list obtained in S1801 and the icon 313 indicating that “history information is usable”, in a set in the menu 312.

In S1808, the CPU 124 displays the n-th sheet type from the head of the supported sheet type list obtained in S1801 and the icon 313 indicating that “history information is not-usable”, in a set in the menu 312.

In S1809, the CPU 124 determines whether or not the counter n has reached Nmax (the number of sheet types included in the supported sheet type list obtained in S1801) that is the maximum value. Specifically, the CPU 124 determines whether the above-mentioned process is performed to the end of the supported sheet type list obtained in S1801. If n=Max is not satisfied, the CPU 124 increments n by one (specifically, sets the next sheet type in the supported sheet type list as a processing target) in S1810, and proceeds to S1804. If n=Nmax is satisfied, the process of FIG. 18 is terminated.

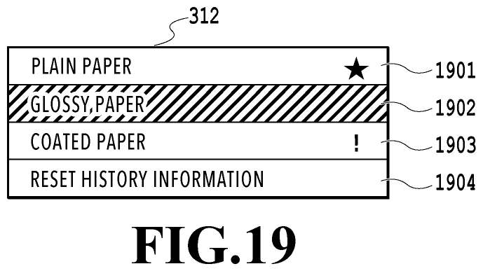

FIG. 19 illustrates an example of the menu 312 in the case where the processes of S1805, S1807, and S1808 are performed. In the menu 312 displayed in FIG. 19, an option 1901 of “plain paper”, an option 1902 of “glossy paper”, and an option 1903 of “coated paper” are displayed as the supported sheet types held by the printer driver 122. In the example of FIG. 19, since “glossy paper” is determined to be not selectable in the printer 101 by the process of S1805, the option 1902 is grayed-out, and is displayed such that the user can identify that the glossy paper is not selectable.

Moreover, quality history information corresponding to the setting history information 206 illustrated in FIG. 5C is saved for “plain paper” and “coated paper”, and setting of “color mode: color” is not usable. In other words, the quality history information associated with “plain paper” is usable. Accordingly, a character string indicating plain paper and an icon of a first display form (icon 313) are displayed in a set in the option 1901 of “plain paper” by the process of S1807. The icon of the first display form is an icon indicating that information set in the past is held and associated setting is usable. A star shape is adopted in the example of FIG. 19 as the first display form. Meanwhile, the quality history information associated with “coated paper” is not usable. Accordingly, a character string indicating coated paper and an icon of a second display form are displayed in a set in the option 1903 of “coated paper” by the process of S1808. The icon of the second display form is an icon indicating that information set in past is held but associated setting is not usable. The second display form is different from the first display form.

A history reset button 1904 is a display item that receives an instruction to reset (delete) the history information and restore a state where an icon indicating that the corresponding option is an option set in the past is not displayed in the menu 312. The icon indicating that the corresponding option is an option set in the past includes the icon of the first display form (icon 313), the icon of the second display form, and the like.

Note that the icon 313 may include a tooltip. For example, as illustrated in FIG. 7, in the case where a pointer portion 700 moving in conjunction with an operation of the operation unit 127 is laid over the icon 313, the CPU 124 displays the tooltip 701. The tooltip 701 includes a message portion 702 presenting setting contents set in the past. The user can check the setting contents set in past for the sheet type associated with the icon 313 only by performing the operation of laying the pointer portion 700 over the icon 313.

In S604, the CPU 124 determines whether at least one of the sheet types is selected or not. Specifically, the CPU 124 determines whether a selection command of selecting one of the multiple setting candidates included in the menu 312 is received or not. This selection command is supplied from the operation unit 127 to the CPU 124. In the case where the CPU 124 receives an instruction of closing the menu 312 without the selection of the setting candidate, the determination result of S604 is false (NO). In this case, the process proceeds to S624. Meanwhile, in the case where the sheet type is selected, the determination result of S604 is true (YES). In this case, the process proceeds to S605.

In S605, the CPU 124 performs print setting of setting the setting candidate (sheet type) selected in S604 in the printer driver 122. In the case where the print setting is performed, the process proceeds to S606.

In S606, the CPU 124 refers to the setting history information 206, and determines whether or not the quality history information is present for the sheet type for which the print setting is performed in S605. If the determination result of S606 is true (YES), the process proceeds to S620. If the determination result of S606 is false (NO), the process proceeds to S608 without proceeding to S620.

In S620, the CPU 124 determines whether the sheet type for which the print setting is performed in S605 is settable or not. As described above in the detailed flowchart of the process of S603, the sheet type that is not selectable in the printer 101 is grayed-out on the menu 312, and is not settable. However, there is a case where an operation of selecting an option indicating a sheet type that is not settable is performed on the menu 312. If the determination result of S620 is false (NO), the process proceeds to S621. If the determination result of S620 is true (YES), the process proceeds to S622.

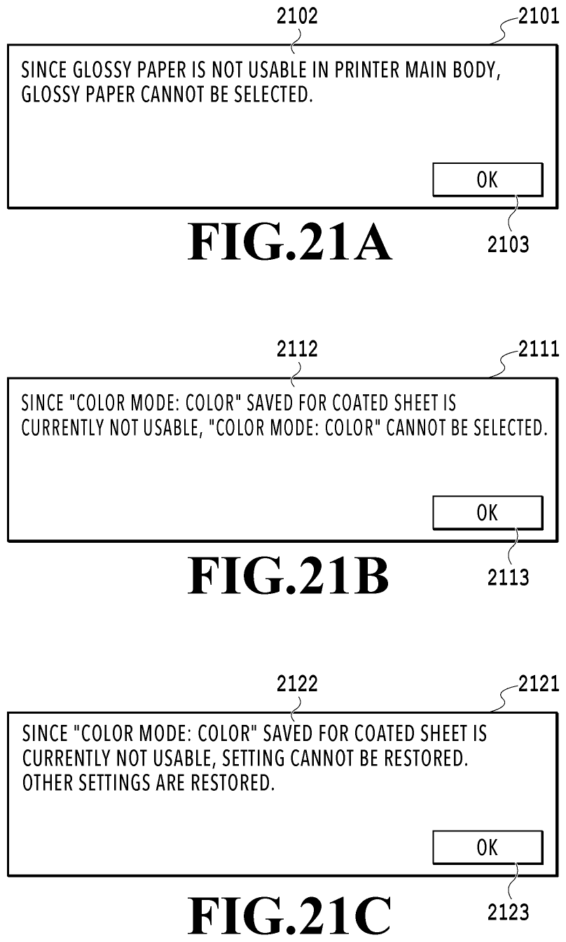

In S621, the CPU 124 performs error display indicating that the selected sheet type is not settable. FIG. 21A illustrates a display example of the error display displayed in S621. For example, in the case where the option of “glossy paper” displayed in a grayed-out manner on the menu 312 has the quality history information and an operation of selecting this option is performed, an error dialog 2101 is displayed. An error message 2102 giving notification that “glossy paper” is not selectable and an OK button 2103 are displayed in the error dialog 2101. In the case where the OK button 2103 is pressed, the error dialog 2101 is hidden, and the process proceeds to S608. The user can recognize that the selected option is not available, and recognize the reason why the option is not available, by viewing the error dialog 2101. In the example of FIG. 21A, the reason why the option is not available is such that the option is not available in the printer main body.

In S622, the CPU 124 determines whether the quality history information associated with the sheet type for which the print setting is performed in S605 is settable or not. As described above in the detailed flowchart of the process of S603, in the case where the quality history information including a currently-not-usable setting is associated with the sheet type, the determination result of S622 is false (NO). If the determination result of S622 is false (NO), the process proceeds to S623. If the determination result of S622 is true (YES), the process proceeds to S607.

In S623, the CPU 124 explicitly indicates which a setting included in the associated quality history information is not available, and performs the error display. FIG. 21B illustrates a display example of the error display displayed in S623. In the example of FIG. 19, in the option 1903, the setting of “color mode: color” that was usable at the time of storing of the quality history information in the past is currently not usable, and the setting history information 206 of “coated paper” is in the state illustrated in FIG. 5C. In the case where this option 1903 is selected, an error dialog 2111 illustrated in FIG. 21B is displayed. In the error dialog 2111, there are displayed an error message 2112 giving notification of the currently-not-settable setting that is the reason why “coated paper” is not selectable and an OK button 2113. In the case where the OK button 2113 is pressed, the error dialog 2111 is hidden, and the process proceeds to S608.

Note that, although a form in which, in the case where a setting included in the quality history information is not settable, setting of the entire quality history information including the sheet type is not allowed is described in the present example, there may be adopted a form in which a setting value that is not settable is explicitly indicated in S623, and the other setting values are set. In this case, in S623, a notification dialog 2121 illustrated in FIG. 21C is displayed instead of the error dialog 2111. In the notification dialog 2121, an error message 2122 and an OK button 2123 are displayed. In the case where the OK button 2123 is pressed, the notification dialog 2121 is hidden, and the process proceeds to S608.

In S607, the CPU 124 refers to the setting history information 206 again, and updates the print setting dialog box 301 (FIG. 3A). Specifically, the CPU 124 obtains the quality history information corresponding to the sheet type for which the print setting is performed in S605. Then, the CPU 124 reflects (sets) the obtained quality history information in the corresponding setting items in the print setting dialog box 301 (FIG. 3A).

For example, assume that the setting history information 206 is in the state of FIG. 5B, and the sheet type for which the print setting is performed in S605 is “plain paper”. In this assumed case, the CPU 124 reflects “CAD drawing” in the pull-down list 314 provided for the setting item of “print objective” in the print setting dialog box 301. In S607, in the case where the contents of the print setting corresponding to the sheet type for which the print setting is performed in S605 are reflected in the print setting dialog box 301, the process proceeds to S608.

Note that the CPU 124 may present that a process of reflecting the contents of the past print setting is ongoing, to the user during the reflection of the quality history information. For example, as illustrated in FIG. 8, the CPU 124 displays the message dialog box 801 at timings such as start of the reference of the setting history information 206. The message dialog box 801 includes a message display portion 802 indicating that the contents of the previous print setting are reflected. In the case where the CPU 124 completes the process of reflecting the quality history information, the CPU 124 automatically closes (hides) the message dialog box 801.

In S608, the CPU 124 enables reception of change commands relating to setting items other than the setting item of sheet type in the print setting dialog box 301. This is because the user desires to change setting of the setting items other than the setting item of sheet type in some cases. For example, there is a case where the user desires to change part of the quality history information reflected in the print setting dialog box 301 in S607. Moreover, there is a case where the setting value of the print objective corresponding to the sheet type selected in S604 is an initial value indicating “standard setting”, and the quality history information is absent.

In the case where the user desires to change the setting other than the setting item of sheet type, the user can operate the operation unit 127 to input change commands relating to the setting items other than the setting item of sheet type. In the case where the CPU 124 receives the change commands relating to the setting items other than the setting item of sheet type, the CPU 124 executes processes according to the received change commands. Changes relating to the setting items other than the setting item of sheet type are performed until the determination result of S609 becomes true (YES) or the determination result of S610 becomes true (YES).

In S609, the CPU 124 determines whether the cancel button 318 of the print setting dialog box 301 is pressed or not. Specifically, the CPU 124 determines whether a discard command of the print setting in the print setting dialog box 301 is received or not. This discard command is supplied from the operation unit 127 to the CPU 124. If the determination result of S609 is true (YES), the series of processes is terminated. If the determination result of S609 is false (NO), the process proceeds to S610.

In S610, the CPU 124 determines whether the OK button 317 of the print setting dialog box 301 is pressed or not. Specifically, the CPU 124 determines whether a finalization command of the print setting in the print setting dialog box 301 is received or not. The finalization command is supplied from the operation unit 127 to the CPU 124. In the case where the determination result of S610 is false (NO), the process returns to S608. In the case where the determination result of S610 is true (YES), the process proceeds to S611.

In S611, the CPU 124 updates the setting history information 206. Specifically, the CPU 124 saves the currently-set quality history information in the setting history information 206 in association with the sheet type. In the case where the setting history information 206 is updated, the series of processes is terminated.

Note that, after the OK button 317 is pressed in S610, the CPU 124 may confirm whether to save the quality history information as history with the user. For example, as illustrated in FIG. 9, the CPU 124 displays the message dialog box 901 before the update of the setting history information 206 in S611. The message dialog box 901 includes a message portion 902, an OK button 903, and a cancel button 904. A message indicating confirmation of whether to save the currently-set contents as history is displayed in the message portion 902. In the case where one of the OK button 903 or the cancel button 904 is pressed, the CPU 124 closes the message dialog box 901. If the OK button 903 is pressed, the process proceeds to S611. Meanwhile, if the cancel button 904 is pressed, the series of processes is terminated.

In S624, the CPU 124 determines whether the history reset button 1904 displayed together with the setting candidates of the sheet type in the menu 312 is pressed or not. In the case where the history reset button 1904 is pressed (selected), the process proceeds to S625. In the case where the CPU 124 receives an instruction to close the menu 312 without the pressing of the history reset button 1904, the determination result of S624 is false (NO). In this case, the series of processes is terminated.

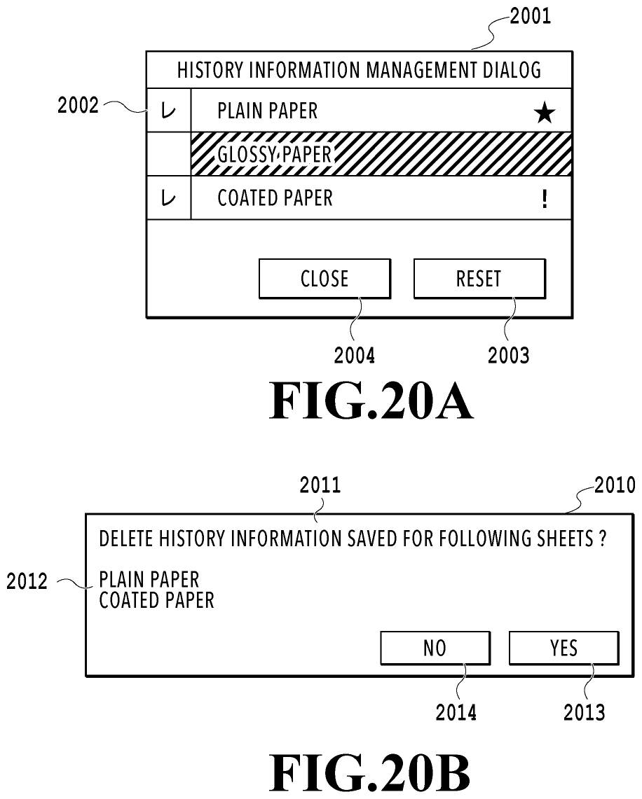

In S625, the CPU 124 displays a history information management dialog. FIG. 20A illustrates a display example of the history information management dialog. In the history information management dialog 2001, the currently-saved quality history information (information indicating whether the corresponding option is an option that has been used or not) can be reset. In the case where the user desires to reset the quality history information, the user checks check boxes 2002 prepared for the respective sheet types, and presses a reset button 2003. In this case, the CPU 124 displays a deletion confirmation dialog 2010 illustrated in FIG. 20B. In the case where a close button 2004 included in the history information management dialog 2001 is pressed, the CPU 124 hides the history information management dialog 2001. In this case, the CPU 124 does not reset the currently-saved quality history information (information indicating whether the corresponding option is an option that has been used or not) for the options (sheet types) whose check boxes 2002 are checked.

Deletion candidates 2012 of the sheet types whose check boxes 2002 are checked and a message confirming permission to delete the quality history information for the deletion candidates 2012 are displayed in a message portion 2011 included in the deletion confirmation dialog 2010. In the case where a yes button 2013 included in the deletion confirmation dialog 2010 is selected, the CPU 124 deletes the quality history information of the sheet types that are the deletion candidates 2012. As a result, for each of the options (sheet types) whose quality history information is deleted, the icon (icon of the first display form or icon of the second display form) indicating that the setting value of this option has been set in the past is not displayed in the case where the menu 312 is displayed next time. Note that options themselves (the respective options of plain paper, glossy paper, and coated paper) are displayed. For example, in the case where the quality history information of the coated paper is deleted, the setting history information 206 of FIG. 5C changes to the setting history information 206 of FIG. 5B. Meanwhile, in the case where a no button 2014 included in the deletion confirmation dialog 2010 is selected, the CPU 124 closes the deletion confirmation dialog 2010. In this case, the CPU 124 does not reset the currently-saved quality history information (information indicating whether the corresponding option is an option that has been used or not) for the options (sheet types) whose check boxes 2002 are checked.

Note that, although the method in which the dialog separate from the menu 312 is displayed and the quality history information of at least one of the sheet types is deleted is adopted, there may be adopted a method in which a check box for deletion is displayed for each sheet type in the menu 312 and the quality history information of at least one of the sheet types is deleted.

Moreover, although the example of deleting the history information (quality history information) of each sheet type (each option) has been explained, the history information (quality history information) of all sheet types may be deleted simultaneously. For example, the CPU 124 deletes the history information (quality history information) of all sheet types based on pressing of the history reset button 1904 displayed together with the setting candidates of the sheet type in the menu 312.

As described above, according to the present embodiment, usability relating to setting can be improved. For example, the CPU 124 displays the sheet type for which the quality history information is present, in an identifiable manner in the menu 312 including multiple setting candidates (sheet types). This allows the user to grasp which sheet type is the sheet type for which the print setting has been performed in the past in a state different from the standard setting, at first glance of the menu 312 without confusion.

Note that, although the example in which the contents set at the time point of the pressing of the OK button 317 in the print setting dialog box 301 are saved (updated) in the setting history information 206 is explained in the present embodiment, the present disclosure is not limited to this. For example, setting contents used in print execution instructed by the user may be saved in the setting history information 206 in response to the instruction of the print execution by the user (that is, after the instruction of the print execution). Moreover, the configuration may be such that the user instructs print execution, and in response to recording of the print data in the print spooler 123 based on this instruction, setting contents used in this print execution are saved in the setting history information 206. Alternatively, the configuration may be such that the user instructs print execution, and in response to transfer of the stored print data from the print spooler 123 to the printer 101, setting contents used in this print execution are saved in the setting history information 206.

According to the present embodiment, the setting candidate that has been set in the past can be identified from among the multiple setting candidates, and usability relating to the print setting can be improved.

### Second Embodiment

### Outline

In the first embodiment, the icon 313 is displayed in association with the setting candidate (sheet type) that has been set in the past to present the sheet type for which the quality history information is present, to the user. Meanwhile, in the present embodiment, an order of use (order of use of the quality history information) that is an order of use in setting in the past is used in the icon display process to further improve the usability. Note that explanation of contents common with the first embodiment is omitted below as appropriate, and differences from the first embodiment are mainly explained.

### Contents of Setting History Information

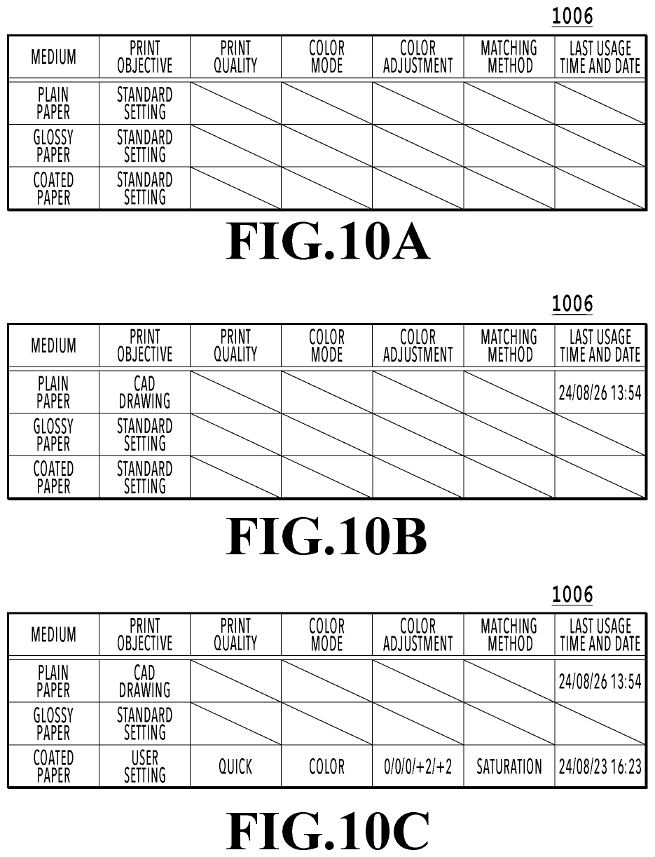

FIGS. 10A to 10C are diagrams illustrating examples of setting history information 1006. Specifically, FIG. 10A is a diagram illustrating an example of an initial state of the setting history information 1006. Moreover, FIG. 10B is a diagram illustrating an example of a state where the setting history information 1006 is updated. Furthermore, FIG. 10C is a diagram illustrating an example of another state where the setting history information 1006 is updated.

In the present embodiment, the setting history information 206 of the first embodiment is replaced by the setting history information 1006. In the setting history information 1006, last usage time and date are newly associated. Specifically, the setting history information 1006 holds the quality history information and the last usage time and date for each sheet type.

Information indicating time and date of last usage of the quality history information associated with each sheet type is stored in “last usage time and date” in the setting history information 1006.

In the case where the setting history information 1006 is in the initial state, as illustrated in FIG. 10A, no information indicating the last usage time and date is associated with (stored for) the “plain paper”, “glossy paper”, and “coated paper”.

Assume that the print objective is then changed in the print setting dialog box 301 (see FIG. 3A). For example, assume that the OK button 317 is pressed in a state where “plain paper” is selected as the sheet type and the print objective of “plain paper” is changed from “standard setting” to “CAD drawing”. In this case, the setting history information 1006 is updated by the identification display processing component 207. Specifically, the setting history information 1006 changes from the state illustrated in FIG. 10A to the state illustrated in FIG. 10B. To be more specific, “standard setting” associated with “plain paper” in the setting history information 1006 is changed to “CAD drawing”. Moreover, information of “13:54, Aug. 26, 2024” that is time and date at which the print setting is finalized is associated with “plain paper”.

Moreover, assume that the printing process is executed in the state where the print objective of “plain paper” is “CAD drawing”, and then the print setting is changed in the print setting dialog box 301 in another printing occasion. For example, assume that the OK button 317 is pressed in a state where “coated paper” is selected as the sheet type and the print objective of “coated paper” is changed from “standard setting” to “user setting”. In this case, the setting history information 1006 is updated by the identification display processing component 207 again. Specifically, the setting history information 1006 changes from the state illustrated in FIG. 10B to the state illustrated in FIG. 10C. To be more specific, “standard setting” associated with “coated paper” in the setting history information 1006 is changed to a setting value indicating “user setting”. Moreover, setting values indicating contents designated by the user in the detailed setting dialog box 302 are stored in “print quality”, “color mode”, “color adjustment”, and “matching method” associated with “coated paper” in the setting history information 1006. Moreover, information of “16:23, August 23, 2024” that is time and date at which the print setting is finalized is associated with “user setting”.

Note that the time and date at which the print setting is finalized may be a time point at which the OK button 317 of the print setting dialog box 301 is pressed. Alternatively, the time and date may be a time point at which the user has instructed print execution. Alternatively, the time and date may be a time point at which the print data is recorded in the print spooler 123.

### Print Setting Process

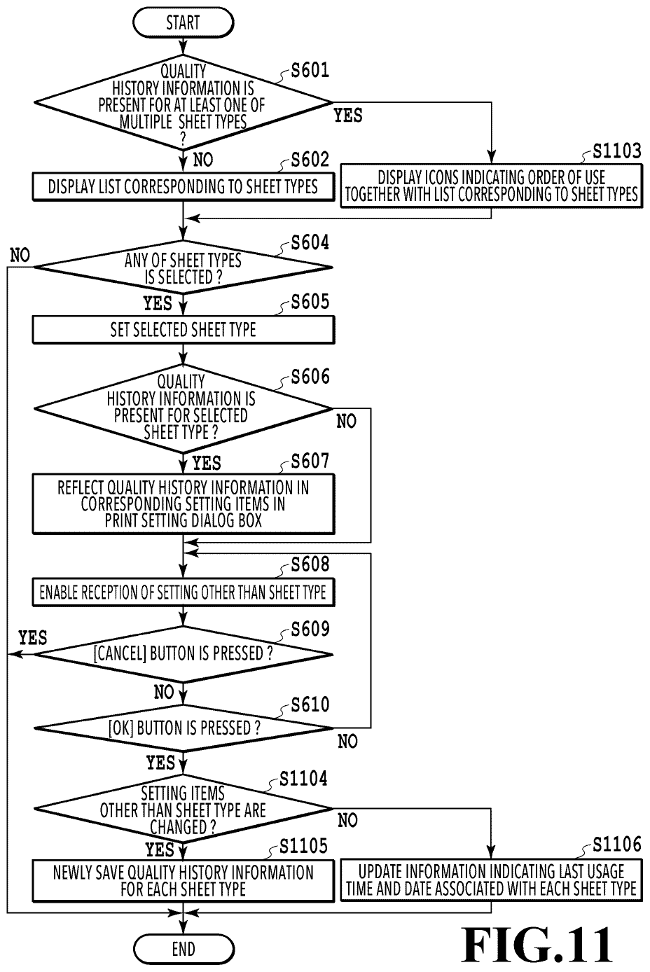

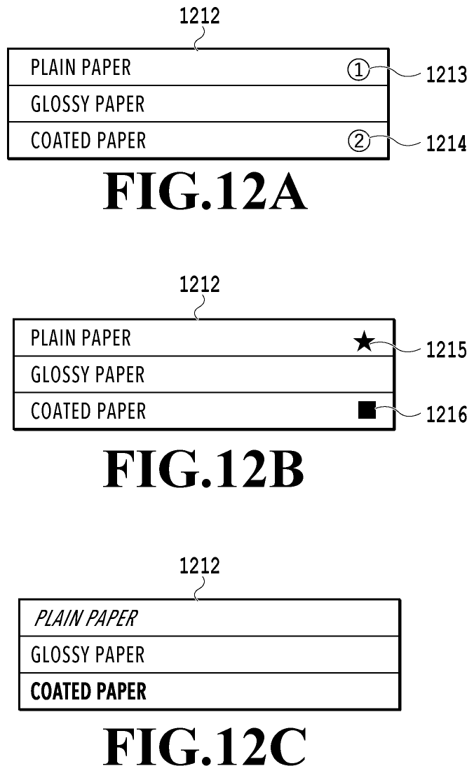

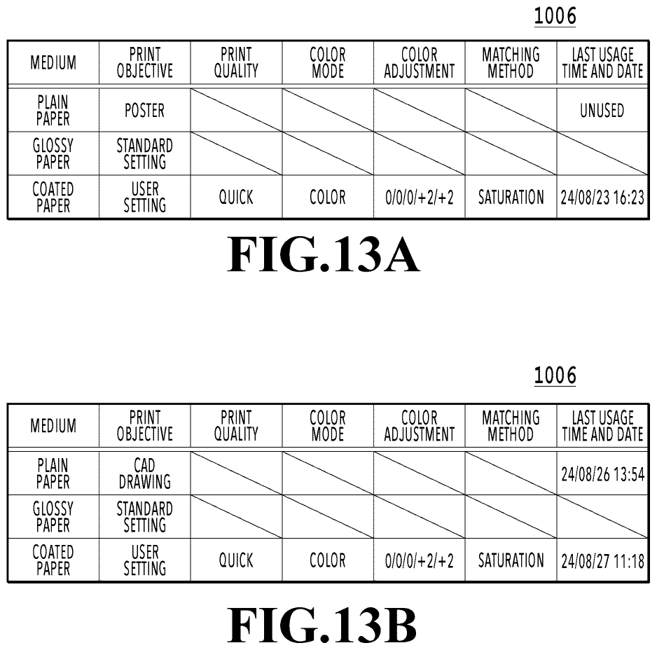

FIG. 11 is a flowchart illustrating an example of a series of processes (print setting process) according to the second embodiment. FIG. 12A is a diagram illustrating an example of a list 1212. FIG. 12B is a diagram illustrating another example of the list 1212. FIG. 12C is a diagram illustrating another example of the list 1212. FIG. 13A is a diagram illustrating an example of the setting history information 1006 after update. FIG. 13B is a diagram illustrating another example of the setting history information 1006 after update. Explanation is given below by using these drawings.

Although the processes of S620 to S625 are not performed in the print setting process of the present embodiment, these processes may be performed. Moreover, the process of S603 in the first embodiment is replaced by a process of S1103 in the print setting process of the present embodiment. Specifically, in the present embodiment, if the determination result of S601 is true (YES), the process proceeds to S1103.

In S1103, the CPU 124 displays the list 1212 corresponding to the sheet types. Moreover, the CPU 124 displays an icon in association with each of the sheet types for which the quality history information is determined to be present in S601. This icon includes a number corresponding to the order of use. The order of use is an order in which the sheet types are used (for which the print setting is performed) in the past.

For example, in the case where the setting history information 1006 is in the state illustrated in FIG. 10C, the order of use is such that “plain paper” is first and “coated paper” is second. The display process (display control) is performed such that this order is identifiable. Specifically, as illustrated in FIG. 12A, the CPU 124 displays an icon 1213 of a display form including the number “1” in association with “plain paper”. Moreover, the CPU 124 displays an icon 1214 of a display form including the number “2” in association with “coated paper”. Note that the display forms of the icons 1213 and 1214 are not limited to those in the example of FIG. 12A as long as the display forms include the numbers corresponding to the order of use.

As described above, the icons 1213 and 1214 indicating the order of use are displayed for the sheet types for which the quality history information is present, among the multiple sheet types included in the list 1212. Accordingly, the user can grasp the sheet types for which setting history other than the standard setting is present, and grasp the order of the setting history at first glance. This facilitates execution of “printing in setting used in immediately-previous printing”.

Note that the shapes of the displayed icons may be changed depending on the order of use, instead of displaying the numbers corresponding to the order of use. For example, as illustrated in FIG. 12B, the CPU 124 displays an icon 1215 with a black star shape such as “★” in association with the lastly-used sheet type (“plain paper”). Moreover, the CPU 124 displays an icon 1216 with a black square shape such as “▪” in association with the second-oldest sheet type (“coated paper”). The CPU 124 may change the color of each icon depending on the order of use, in addition to the shape of the icon or instead of the shape of the icon.

Moreover, instead of displaying the icons, display forms of the multiple setting candidates included in the list 1212 themselves may be changed. For example, as illustrated in FIG. 12C, the CPU 124 changes the font of the lastly-used sheet type (“plain paper”) to an italic face. Moreover, the CPU 124 changes the font of the second-oldest sheet type (“coated paper”) to a bold face. The CPU 124 may change the color of each setting candidate (sheet type) depending on the order of use, in addition to the font of the setting candidate or instead of the font of the setting candidate.

Furthermore, although not illustrated, the last usage time and date themselves may be displayed in association with the sheet type for which the quality history information is determined to be present in S601, instead of displaying the icons.

Moreover, an upper limit may be provided for the number of icons indicating the order of use. This can maintain the list in an easily-viewable state. Note that the CPU 124 may be capable of changing setting of the upper limit of the number of icons indicating the order of use depending on an operation of the user. The number of icons displayed on the list can be thereby adjusted in consideration of a level at which the list is difficult to view.

Furthermore, in the print setting process of the present embodiment, the process of S611 in the first embodiment is replaced by processes of S1104 of S1106. Specifically, in the present embodiment, if the determination result of S610 is true (YES), the process proceeds to S1104.

In S1104, the CPU 124 determines how the setting history information 1006 is to be updated. Specifically, the CPU 124 determines whether a change of setting items other than the setting item of sheet type is received in S608. If the determination result of S1104 is true (YES), the process proceeds to S1105. Meanwhile, if the determination result of S1104 is false (NO), the process proceeds to S1106.

In S1105, the CPU 124 newly saves the quality history information for each sheet type in the setting history information 1006. This is because the setting items other the setting item of sheet type is changed in S608. In other words, this is because part of the quality history information is changed or the quality history information is newly created (set). In the case where the quality history information corresponding to the sheet type is already present in the setting history information 1006, the CPU 124 overwrites the changed quality history information, and saves the changed quality history information as new quality history information. Meanwhile, in the case where the quality history information corresponding to the sheet type is absent in the setting history information 1006, the CPU 124 newly creates an item of this sheet type, and saves the quality history information in association with the created item.

For example, assume that, in the case where the setting history information 1006 is in the state of FIG. 10C, “plain paper” is selected in the pull-down list 311 of the print setting dialog box 301 and “CAD drawing” is selected in the pull-down list 314. If “CAD drawing” is changed to “poster” in this assumed case, the setting history information 1006 changes from the state of FIG. 10C to the state of FIG. 13A. In this case, since printing has never been performed for the newly-overwritten and saved quality history information, the information indicating the last usage time and date associated with “plain paper” is “unused”. In the case where the quality history information for which the information indicating the last usage time and date is “unused” is present, in S1003 described above, the CPU 124 may display an icon indicating that the quality history information is newly-registered quality history information. For example, an icon indicating a character string such as “new” is displayed. This allows the user to recognize that the quality history information is newly-registered quality history information at first glance. Note that the smallest number (first) in the order of use may be displayed in association with the corresponding sheet type also for the quality history information for which printing has been never performed.

In S1106, the CPU 124 updates the information indicating the last usage time and date for each sheet type. This is due to the following reason. Since the setting items other than the setting item of sheet type are not changed in S608, the existing quality history information can be used, and updating of the information indicating the last usage time and date alone is sufficient.

For example, assume that, in the case where the setting history information 1006 is in the state of FIG. 10C, “coated paper” is selected in the pull-down list 311 of the print setting dialog box 301 and “user setting” is selected in the pull-down list 314. If printing is executed in this setting without a change in this assumed case, the setting history information 1006 changes from the state of FIG. 10C to the state of FIG. 13B. In this case, the information indicating the last usage time and date associated with “coated paper” is updated from “16:23, Aug. 23, 2024” to “11:18, Aug. 27, 2024”.

In the case where the process of S1105 or the process of S1106 described above is completed, the print setting process (series of processes) is terminated.

According to the present embodiment, in the case where there are multiple setting candidates that has been set in the past, the user can grasp the setting candidate lastly used among these setting candidates at first glance, and the usability relating to the print setting can be improved.

### Third Embodiment

### Outline

In the first embodiment, the icon 313 is displayed in association with the setting candidate (sheet type) that has been set in the past to present the sheet type for which the quality history information is present, to the user. Meanwhile, in the present embodiment, the number of times of usage of the quality history information is used in the icon display process to further improve the usability. Note that explanation of contents common with the first embodiment is omitted below as appropriate, and differences from the first embodiment are mainly explained.

### Contents of Setting History Information

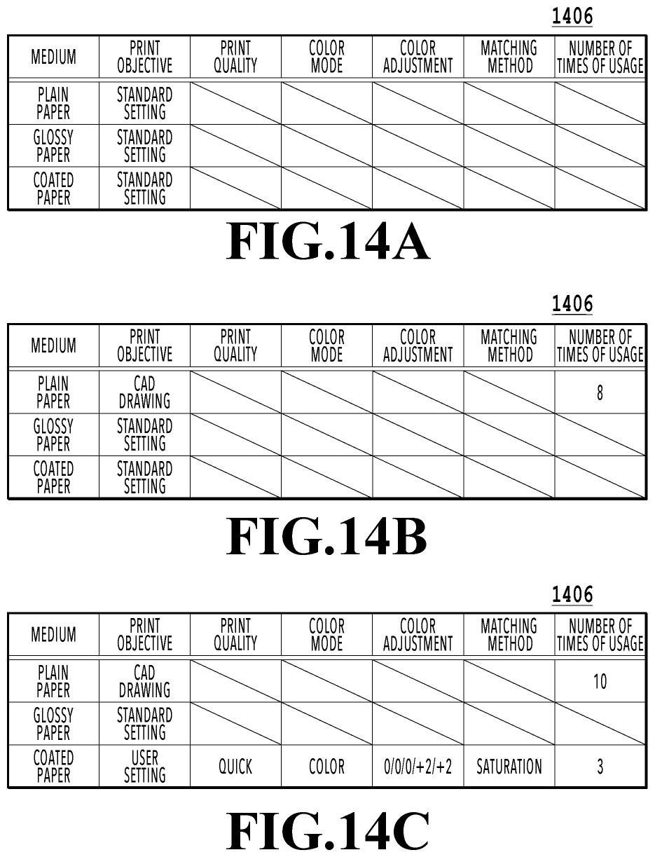

FIGS. 14A to 14C are diagrams illustrating an example of setting history information 1406. Specifically, FIG. 14A is a diagram illustrating an example of an initial state of the setting history information 1406. Moreover, FIG. 14B is a diagram illustrating an example of a state where the setting history information 1406 is updated. Furthermore, FIG. 14C is a diagram illustrating an example of another state where the setting history information 1406 is updated.

In the present embodiment, the setting history information 206 of the first embodiment is replaced by the setting history information 1406. In the setting history information 1406, the number of times of usage is newly associated. Specifically, the setting history information 1406 holds the quality history information and the number of times of usage for each sheet type.

Information indicating the number of times the quality history information associated with each sheet type is used is stored in “number of times of usage” in the setting history information 1406.

In the case where the setting history information 1406 is in the initial state, as illustrated in FIG. 14A, no information indicating the number of times of usage is associated with (stored for) “plain paper”, “glossy paper”, and “coated paper”.

Moreover, assume that printing is performed eight times in a state where “plain paper” is selected as the sheet type and “CAD drawing” is selected as the print objective of “plain paper”. In this case, the setting history information 1406 is in the state illustrated in FIG. 14B. The setting history information 1406 is updated by the identification display processing component 207.

Assume that printing in which the sheet type is “plain paper” and the print objective of “plain paper” is “CAD drawing” is then performed again twice. Moreover, assume that printing is additionally performed three times in a state where “coated paper” is selected as the sheet type and “user setting” is selected as the print objective of “coated paper”. In this case, the setting history information 1406 is in the state illustrated in FIG. 14C. The setting history information 1406 is updated by the identification display processing component 207.

### Print Setting Process

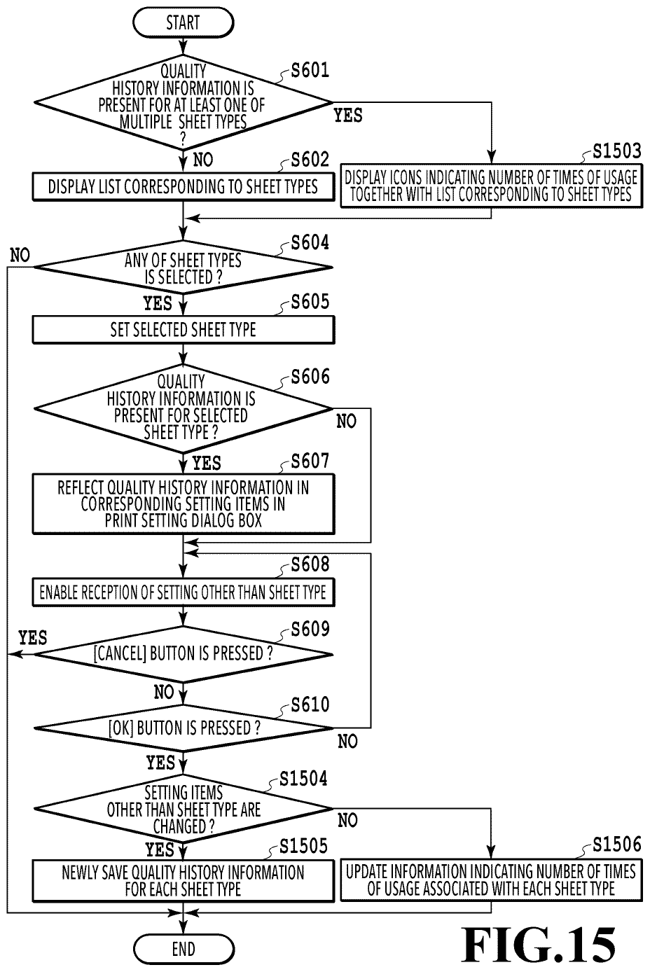

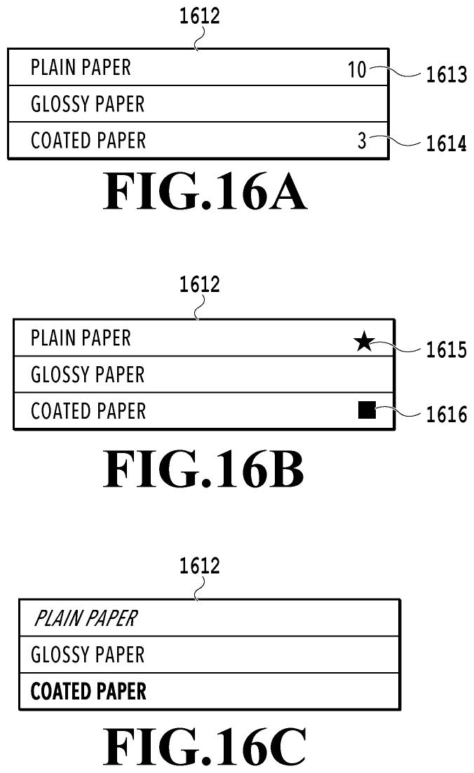

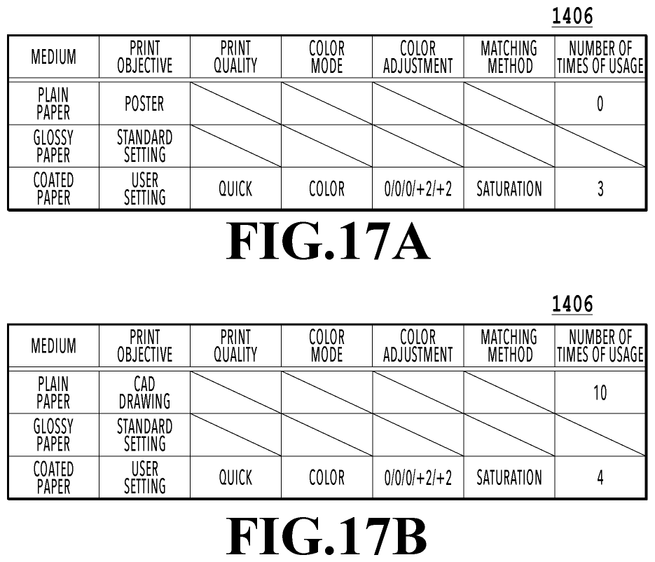

FIG. 15 is a flowchart illustrating an example of a series of processes (print setting process) according to the third embodiment. FIG. 16A is a diagram illustrating an example of a list 1612. FIG. 16B is a diagram illustrating another example of the list 1612. FIG. 16C is a diagram illustrating another example of the list 1612. FIG. 17A is a diagram illustrating an example of the setting history information 1406 after update. FIG. 17B is a diagram illustrating another example of the setting history information 1406 after update. Explanation is given below by using these drawings.

Although the processes of S620 to S625 are not performed in the print setting process of the present embodiment, these processes may be performed. Moreover, the process of S603 in the first embodiment is replaced by a process of S1503 in the print setting process of the present embodiment. Specifically, in the present embodiment, if the determination result of S601 is true (YES), the process proceeds to S1503.

In S1503, the CPU 124 displays the list 1612 corresponding to the sheet types. Moreover, the CPU 124 displays an icon in association with each of the sheet types for which the quality history information is determined to be present in S601. This icon includes a number corresponding to the number of times of usage.

For example, in the case where the setting history information 1406 is in the state illustrated in FIG. 14C, the number of times of usage corresponding to “plain paper” is “10”, and the number of times of usage corresponding to “coated paper” is “3”. The display process (display control) is performed such that these numbers of times of usage are identifiable. Specifically, as illustrated in FIG. 16A, the CPU 124 displays an icon 1613 of a display form of “10” in association with “plain paper”. Moreover, the CPU 124 displays an icon 1614 of a display form of “3” in association with “coated paper”. Note that the display forms of the icons 1613 and 1614 are not limited to those in the example of FIG. 16A as long as the display forms include numbers corresponding to the numbers of times of usage.

As described above, the icons 1613 and 1614 indicating the numbers of times of usage are displayed for the sheet types for which the quality history information is present, among the multiple sheet types included in the list 1612. Accordingly, the user can grasp the sheet types for which history of printing performed in setting other than the standard setting is present, and grasp how many times this printing history has been used at first glance. This facilitates execution of “printing in setting used multiple times in the past”.

Note that the shapes of the displayed icons may be changed depending on the numbers of times of usage, instead of displaying the numbers corresponding to the numbers of times of usage. For example, as illustrated in FIG. 16B, the CPU 124 displays an icon 1615 with a black star shape such as “★” in association with the most-used sheet type (“plain paper”). Moreover, the CPU 124 displays an icon 1616 with a black square shape such as “▪” in association with the second-most-used sheet type (“coated paper”). Alternatively, the configuration may be such that icons with varying shapes are associated with the respective numbers of times of usage and the shapes of the icons corresponding to the numbers of times of usage are displayed. Moreover, the CPU 124 may change the color of each icon depending on the number of times of usage, in addition to the shape of the icon or instead of the shape of the icon.

Moreover, instead of displaying the icons, display forms of the multiple setting candidates (sheet types) displayed in the list 1612 may be changed. For example, as illustrated in FIG. 16C, the CPU 124 changes the font of the most-used sheet type (“plain paper”) to an italic face. Moreover, the CPU 124 changes the font of the second-most-used sheet type (“coated paper”) to a bold face. The CPU 124 may change the color of each setting candidate (sheet type) depending on the number of times of usage, in addition to the font of the setting candidate or instead of the font of the setting candidate.

Furthermore, an upper limit may be provided for the number of icons indicating the numbers of times of usage. This can maintain the list in an easily-viewable state. Note that the CPU 124 may be capable of changing setting of the upper limit of the number of icons indicating the numbers of times of usage, depending on an operation of the user. The number of icons displayed on the list can be thereby adjusted in consideration of a level at which the list is difficult to view.

In the print setting process of the present embodiment, the process of S611 in the first embodiment is replaced by processes of S1504 of S1506. Specifically, in the present embodiment, if the determination result of S610 is true (YES), the process proceeds to S1504.

In S1504, the CPU 124 determines whether a change of the setting items other than the setting item of sheet type is received in S608. If the determination result of S1504 is true (YES), the process proceeds to S1505. Meanwhile, if the determination result of S1504 is false (NO), the process proceeds to S1506.

In S1505, the CPU 124 newly saves the quality history information for each sheet type in the setting history information 1406. Specifically, in the case where the quality history information corresponding to the sheet type is already present in the setting history information 1406, the CPU 124 overwrites the changed quality history information, and saves the changed quality history information as new quality history information. Meanwhile, in the case where the quality history information corresponding to the sheet type is absent in the setting history information 1406, the CPU 124 newly creates an item of the sheet type, and saves the quality history information in association with the created item.

For example, assume that, in the case where the setting history information 1406 is in the state of FIG. 14C, “plain paper” is selected in the pull-down list 311 of the print setting dialog box 301 and “CAD drawing” is selected in the pull-down list 314. If “CAD drawing” is changed to “poster” in this assumed case, the setting history information 1406 changes from the state of FIG. 14C to the state of FIG. 17A. In this case, since printing has never been performed for the newly-overwritten and saved quality history information, the number of times of usage associated with “plain paper” is “0”. In the case where the quality history information for which the number of times of usage is “0” is present, in S1503 described above, the CPU 124 may display an icon indicating that the quality history information is newly-registered quality history information. For example, an icon indicating a character string such as “new” is displayed. This allows the user to recognize that the quality history information is unprinted, newly-registered quality history information, at first glance.

In S1506, the CPU 124 updates the information indicating the number of times of usage for each sheet type. This is due to the following reason. Since the setting items other than the setting item of sheet type is not changed in S608, the existing quality history information can be used, and updating of the information indicating the number of times of usage alone is sufficient.

For example, assume that, in the case where the setting history information 1406 is in the state of FIG. 14C, “coated paper” is selected in the pull-down list 311 of the print setting dialog box 301 and “user setting” is selected in the pull-down list 314. If printing is executed in this setting without a change in this assumed case, the setting history information 1406 changes from the state of FIG. 14C to the state of FIG. 17B. In this case, the information indicating the number of times of usage associated with “coated paper” is updated from “3” to “4”.

In the case where the process of S1505 or the process of S1506 described above is completed, the print setting process (series of processes) is terminated.

According to the present embodiment, in the case where there are multiple setting candidates that has been set in the past, the user can grasp the setting candidate most used among these setting candidates at first glance, and the usability relating to the print setting can be improved.

### Other Embodiments

Note that, although the sheet type for which the setting value varying from the initial value (standard setting) has been set in the setting item of print objective in the past is displayed in an identifiable manner in the above-mentioned embodiment, the present disclosure is not limited to this. The present disclosure may also include displaying the sheet type that has been set in the past in an identifiable manner, irrespective of the setting value in the setting item of print objective. For example, information indicating the sheet type selected in the pull-down list 311 in the case where the OK button 317 is pressed in the print setting dialog box 301 (see FIG. 3A) is saved in the setting history information. In the case where the menu 312 including multiple setting candidates (sheet types) is displayed, the CPU 124 displays the sheet type saved in this setting history information in an identifiable manner. Also in this case, the user can grasp the sheet type for which the print setting has been performed in the past at first glance in the menu 312 without confusion.

Moreover, the above-mentioned various types of control explained to be performed by the CPU 124 may be performed by one piece of hardware. Alternatively, multiple pieces of hardware (for example, multiple processors and circuits) may share processes to control the entire apparatus.

Furthermore, although the present disclosure has been described in detail based on the preferred embodiments of the present disclosure, the present disclosure is not limited to these specific embodiments, and various forms within a scope not departing from the spirit of the present disclosure are also included in the present disclosure. For example, although the above-mentioned embodiments may be combined as appropriate.

Moreover, although the above-mentioned embodiments are explained by using the case where the present disclosure is applied to the PC 102 as an example, the present disclosure is not limited to this example. The present disclosure may be applied to an information processing apparatus that has a function of displaying multiple setting candidates (multiple options) settable for a certain setting item and setting the setting candidate selected by the user from among the displayed multiple setting candidates. Specifically, the present disclosure may be applied to a PDA, a mobile phone terminal, a portable image viewer, a printer apparatus including a display, a digital photo frame, a music player, a game console, an electronic book reader, and the like. Application is not limited to control of a printer. Moreover, the display method of multiple setting candidates (multiple options) is not limited to a pull-down menu, and may be any display form in which multiple setting candidates including setting candidates that have been set in the past and setting candidates that have never been set in the past in a mixed manner are arranged and displayed as options.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to improve usability in selection of a setting candidate from among multiple setting candidates.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-200916, filed Nov. 18, 2024 and Japanese Patent Application No. 2025-171943, filed Oct. 10, 2025, which is hereby incorporated by reference herein in its entirety.

What is claimed is:

1. An information processing apparatus comprising at least one memory and at least one processor which function as:
a display control unit configured to perform control to display a plurality of setting candidates for a first setting item and execute identification display in which the setting candidate that has been set in the past among the plurality of setting candidates is indicated;
a reception unit configured to receive an operation of selecting one of the plurality of setting candidates;
a setting unit configured to set the selected setting candidate among the plurality of setting candidates; and
a control unit configured to perform control to cancel the identification display even in a case where the plurality of setting candidates are displayed, based on execution of a specific operation from a user after execution of the identification display.

2. The information processing apparatus according to claim 1, wherein the specific operation is an operation of instructing reset of history relating to the first setting item.

3. The information processing apparatus according to claim 1, wherein the display control unit further performs control to display a display item for receiving the specific operation, together with the plurality of setting candidates.

4. The information processing apparatus according to claim 1, further comprising a second reception unit configured to receive an operation of selecting one or more setting candidates for which the identification display is to be cancelled, among the plurality of setting candidates, wherein
the control unit performs control to cancel the identification display for the one or more setting candidates for which selection is received by the second reception unit, based on the execution of the specific operation.

5. The information processing apparatus according to claim 1, wherein the control unit performs control to cancel the identification display for all of the plurality of setting candidates, based on the execution of the specific operation.

6. The information processing apparatus according to claim 1, wherein the control unit performs control to delete history information stored in association with the setting candidate, based on the execution of the specific operation.

7. The information processing apparatus according to claim 1, wherein
the display control unit further performs confirmation display of confirming permission to delete history information stored in association with the setting candidate, in response to the execution of the specific operation, and
the control unit performs control to delete the history information stored in association with the setting candidate, in a case where a confirmation operation from the user is made in a state where the confirmation display is executed.

8. The information processing apparatus according to claim 1, wherein the display control unit further performs display in which the setting candidate that is not settable among the plurality of setting candidates is indicated.

9. The information processing apparatus according to claim 1, wherein the display control unit performs control to also display the setting candidate that has not been set in the past as the plurality of setting candidates.

10. The information processing apparatus according to claim 1, wherein the display control unit performs control to display a first setting candidate that has been set in the past and a second setting candidate that has not been set in the past side as the plurality of setting candidates by side in the same row and perform the identification display such that the first setting candidate and the second setting candidate are distinguishable from each other.

11. The information processing apparatus according to claim 1, wherein, based on reception of the operation of selecting one of the plurality of setting candidates in the reception unit, the setting unit sets both of a setting value of the first setting item corresponding to the selected setting candidate and a setting value of a second setting item stored in association with the selected setting candidate.

12. The information processing apparatus according to claim 11, wherein the display control unit further displays whether the setting value of the second setting item stored in association with the setting candidate that has been set in the past among the plurality of setting candidates is usable or not in an identifiable manner.

13. The information processing apparatus according to claim 11, wherein, based on selection of the setting candidate that has been set in the past among the plurality of setting candidates and for which the setting value of the second setting item stored in association is usable, the display control unit further performs control to display the setting value of the second setting item that is unusable.

14. The information processing apparatus according to claim 1, wherein the display control unit fixes an order in which the plurality of setting candidates are arranged side by side.

15. The information processing apparatus according to claim 1, wherein the display control unit displays a number in an order of use as the identification display.

16. The information processing apparatus according to claim 1, wherein the display control unit displays a specific item in association with the setting candidate that has been set in the past, as the identification display.

17. The information processing apparatus according to claim 16, wherein the specific item includes at least one of a specific icon, a display object indicating the accumulated number of times of usage, and a display object indicating time and date of last usage.

18. The information processing apparatus according to claim 1, wherein the number of the setting candidates for which the identification display is performed by the display control unit is limited to an upper limit number determined in advance.

19. The information processing apparatus according to claim 18, wherein the upper limit number is changeable based on an operation of the user.

20. An information processing method comprising the steps of:
performing control to display a plurality of setting candidates for a first setting item and execute identification display in which the setting candidate that has been set in the past among the plurality of setting candidates is indicated;
receiving an operation of selecting one of the plurality of setting candidates;
setting the selected setting candidate among the plurality of setting candidates; and
performing control to cancel the identification display even in a case where the plurality of setting candidates are displayed, based on execution of a specific operation from a user after execution of the identification display.

21. A non-transitory computer readable storage medium storing a program for causing a computer to perform a control method of controlling an information processing apparatus, the control method comprising the steps of:
performing control to display a plurality of setting candidates for a first setting item and execute identification display in which the setting candidate that has been set in the past among the plurality of setting candidates is indicated;
receiving an operation of selecting one of the plurality of setting candidates;
setting the selected setting candidate among the plurality of setting candidates; and
performing control to cancel the identification display even in a case where the plurality of setting candidates are displayed, based on execution of a specific operation from a user after execution of the identification display.
